(19) United States
(12) Patent Application Publication
(10) Pub. No.: US 2024/0039860 A1
(43) Pub. Date: Feb. 1, 2024

(54) METHODS, SYSTEMS, APPARATUS, AND ARTICLES OF MANUFACTURE TO MANAGE NETWORK COMMUNICATIONS IN TIME SENSITIVE NETWORKS

(71) Applicant: Intel Corporation, Santa Clara, CA (US)

(72) Inventors: Raju Arvind, Bangalore (IN); Amit Baxi, Bengaluru (IN); Dave Cavalcanti, Portland, OR (US); Trevor Cooper, Portland, OR (US); Andrew Cunningham, Ennis (IE); Francesc Guim Bernat, Barcelona (ES); Ravindra Hegde, Bangalore (IN); Gowtham Hosamane, Bangalore (IN); Karthik Kumar, Chandler, AZ (US); Patrick Kutch, Tigard, OR (US); Susruth Sudhakaran, Portland, OR (US)

(21) Appl. No.: 18/478,589

(22) Filed: Sep. 29, 2023

(30) Foreign Application Priority Data
Jul. 19, 2023 (IN) 202341048353

(51) Int. Cl. H04L 47/32; H04L 47/10

(52) U.S. Cl. CPC H04L 47/32; H04L 47/29

(57) ABSTRACT

Systems, apparatus, articles of manufacture, and methods are disclosed. An example apparatus disclosed herein is to determine whether to drop a data packet of a data stream or forward the data packet based on (a) a payload of the data packet and (b) historic information associated with the data stream. The example apparatus is also to operate on the data packet based on the determination.

### RELATED APPLICATION

This patent claims priority to Indian Provisional Patent Application No. 202341048353, which was filed on Jul. 19, 2023. Indian Provisional Patent Application No. 202341048353 is hereby incorporated herein by reference in its entirety.

### FIELD OF THE DISCLOSURE

This disclosure relates generally to network communication and, more particularly, to methods, systems, apparatus, and articles of manufacture to manage network communications in time sensitive networks.

### BACKGROUND

Edge computing, at a general level, refers to the transition of compute and storage resources closer to endpoint devices (e.g., consumer computing devices, user equipment, etc.) to optimize total cost of ownership, reduce application latency, improve service capabilities, and improve compliance with security or data privacy requirements. In some edge network environments, data is transmitted in the form of network packets between edge devices (e.g., edge computing devices). For instance, data can be collected and packetized into a network packet (e.g., a data packet), which is then sent to a scheduler of a network interface controller (NIC) responsible for dispatching the network packet to a target computing device. In recent years, time-sensitive networking (TSN) has been developed to reduce latency and/or jitter in transmission of network packets between edge devices. Time sensitive networks provide time synchronization and packet scheduling to ensure latency targets are satisfied for network packets sent between devices.

### BRIEF DESCRIPTION OF THE DRAWINGS

FIG. 1 illustrates an example representation of an edge cloud configuration for edge computing.

FIG. 2 illustrates operational layers among endpoints, an edge cloud, and cloud computing environments.

FIG. 3 illustrates an example approach for networking and services in an edge computing system.

FIG. 4 illustrates a compute and communication use case involving mobile access to applications in an edge computing system.

FIG. 5A provides an overview of example components for compute deployed at a compute node in an edge computing system.

FIG. 5B provides a further overview of example components within a computing device in an edge computing system.

FIG. 6 illustrates an example cluster of nodes in an example time sensitive network (TSN) environment.

FIG. 7 illustrates an example system including an example control node that implements example stream mapping circuitry and an example edge node that implements example state manager circuitry in accordance with teachings of this disclosure.

FIG. 8 illustrates example implementations of the example control node and the example edge node of FIG. 7.

FIG. 9 is a block diagram of the example stream mapping circuitry of FIGS. 7 and/or 8.

FIG. 10 is a table representing example compression schemes that can be implemented by the example stream mapping circuitry of FIG. 9.

FIG. 11 illustrates an example process flow for implementing an example stream allocation procedure in accordance with teachings of this disclosure.

FIG. 12 is a flowchart representative of example machine readable instructions and/or example operations that may be executed, instantiated, and/or performed by example programmable circuitry to implement the example stream mapping circuitry of FIG. 9.

FIG. 13 illustrates an example system for managing data ingestion, where the system includes an example platform and an example network interface card implementing example utility evaluation circuitry in accordance with teachings of this disclosure.

FIG. 14 is a block diagram of the example utility evaluation circuitry of FIG. 13.

FIG. 15 is a flowchart representative of example machine readable instructions and/or example operations that may be executed, instantiated, and/or performed by example programmable circuitry to implement the example utility evaluation circuitry of FIG. 14 to register a new entropy function.

FIG. 16 is a flowchart representative of example machine readable instructions and/or example operations that may be executed, instantiated, and/or performed by example programmable circuitry to implement the example utility evaluation circuitry of FIG. 14 to determine whether to drop or forward an example data packet.

FIG. 17 is a block diagram of an example processing platform including programmable circuitry structured to execute, instantiate, and/or perform the example machine readable instructions and/or perform the example operations of FIG. 12 to implement the example stream mapping circuitry of FIG. 9.

FIG. 18 is a block diagram of an example processing platform including programmable circuitry structured to execute, instantiate, and/or perform the example machine readable instructions and/or perform the example operations of FIGS. 15 and/or 16 to implement the utility evaluation circuitry of FIG. 14.

FIG. 19 is a block diagram of an example implementation of the programmable circuitry of FIGS. 17 and/or 18.

FIG. 20 is a block diagram of another example implementation of the programmable circuitry of FIGS. 17 and/or 18.

FIG. 21 is a block diagram of an example software/firmware/instructions distribution platform (e.g., one or more servers) to distribute software, instructions, and/or firmware (e.g., corresponding to the example machine readable instructions of FIGS. 12, 15, and/or 16) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Methods, systems, apparatus, and articles of manufacture to manage network communications in time sensitive networks are disclosed. In some network environments, real time traffic may experience excessive latencies and/or jitter when networks grow congested with multiple transmit and receive hosts. In recent years, Time-Sensitive Networks (TSN) have been developed to reduce latency and/or jitter in networks by synchronizing clocks, allocating resources (e.g., bandwidth and/or time) between nodes, and/or prioritizing real time data streams across the network.

However, in some applications, bandwidth, latency, and/or other quality of service (QoS) requirements between nodes in a network can vary over time. In some industrial applications, for example, the expected QoS between nodes can vary based on a phase of production on a factory floor. For example, for a first operation (e.g., an automated paint inspection operation) performed at a first assembly line using wirelessly connected cameras mounted on robots, uplink bandwidth utilization may increase when computationally-intensive tasks (e.g., artificial intelligence (AI) inferencing, image processing, etc.) are being performed at a network edge. In some instances, the network edge can also control a second operation (e.g., a robotic welding operation) at a second assembly line, where the second operation may expect different QoS levels based on, for instance, distance(s) between robot arms and one or more objects on the second assembly line. For such networks having temporally varying QoS expectations (e.g., related to latency, bandwidth, etc.), examples disclosed herein provide techniques to manage and/or satisfy the changing QoS expectations across a network.

In some examples, overprovisioning of a system is used to account for changing QoS expectations of the system. In an overprovisioned system, additional bandwidth and/or resources are allocated to corresponding communication links, such that a portion (e.g., all) of the communication links satisfy a highest expected QoS level for the system. However, some applications may not necessitate the highest QoS level and/or do not utilize the highest QoS level at the same time, resulting in wasted and/or unused resources in the system. Thus, while overprovisioning may be viable in small scale and/or dedicated wired networks (e.g., a network where links have a fixed and/or known capacity), for dynamic networks having links (e.g., wireless links) with variable capacity and/or variable bandwidth constraints, overprovisioning and/or using the highest QoS level may not be desirable and/or efficient.

Further, in recent years, increasing volumes of data have been observed in some network environments (e.g., involving smart cities and/or analytics) in which thousands of sensors and/or other sources send data streams to one or more servers (e.g., server platforms). In some cases, large volumes of data arriving with high transfer rates at the server(s) can produce a number of challenges. For instance, the server(s) often store the data in-memory for in-memory analytics (e.g., for cases in which the data is to be operated on at memory speeds). However, the server(s) typically have limited memory to store such data, thus necessitating prioritization of the processing of the data. Further, when the server(s) are to process multiple parallel streams, it may be difficult to arrange and/or process incoming data while ensuring that the data stored in-memory is representative of a system being monitored.

Typically, servers that receive multiple streams of data parse a portion (e.g., some or all) of the data to determine how to handle the data (e.g., whether to discard data and/or retain the data in memory for processing and/or storage) based on one or more rules and/or policies (e.g., user-defined and/or predetermined rules). For example, the rules can be based on data pattern type, time-of-day, carbon-monoxide level, indoor temperature, etc. In some examples, a server can monitor an incoming data stream for particular data patterns, and/or the server can average a portion (e.g., all) of the data within a particular range. In some such instances, the server stores and/or retains data that satisfies the one or more rules, and the server does not store (e.g., discards) data that does not satisfy the one or more rules. At scale, such determinations may be difficult to perform quickly and efficiently, especially in cases where real time analytics are to be performed on the data. Further, to implement such rule(s) in software, the server stores (e.g., at least temporarily) a portion (e.g., some or all) of the incoming data in memory. Such an approach can work for relatively few incoming streams, but may result in a bottleneck when there are a large number (e.g., thousands, tens of thousands, etc.) of incoming streams.

In some examples, much of the incoming data has low (or no) utility (e.g., entropy) relative to a full dataset (e.g., all collected information) for a system. As used herein, utility refers to a measure of variability of data and/or information provided by the data relative to previously collected data for a given data stream. For example, for data that is relatively unchanging (e.g., variability between the data and the previously collected data is relatively small and/or less than a threshold), the corresponding utility is relatively low. Conversely, for data that is highly variable and/or anomalous (e.g., the difference(s) between the data and the previously collected data is greater than or equal to the threshold), the corresponding utility is relatively high. Stated differently, data having high utility provides a greater amount of new and/or useful information compared to data having low utility.

In some examples, low utility is common for discrete sensor data. For instance, variation of data over time can be relatively small (e.g., less than a threshold) for some sensors (e.g., temperature sensors, carbon monoxide sensors, and/or video cameras) implemented in remote locations. Further, in some examples, there can be a large number (e.g., thousands) of such sensors in physical proximity to one another, resulting in information redundancy (e.g., low utility) in the sensor data due to spatial overlap of the sensors. Since the sensors independently stream data to a server and/or a set of servers, such information redundancy may be undetectable at the stream level.

Examples disclosed herein determine whether to drop or forward a data packet of a data stream based on an example utility value (e.g., an entropy value) corresponding to the data packet. Examples disclosed herein enable an example software stack to register one or more example utility functions (e.g., entropy functions) at example network interface hardware (e.g., a network interface card (NIC), an infrastructure processing unit (IPU), etc.), where the utility functions can be mapped to respective example queues (e.g., network queues, processing queues, Application Device Queues, etc.) at the network interface hardware. In some examples, the utility function(s) correspond to filters, custom sampling techniques, and/or other data shaping techniques that can be applied to incoming data. Examples disclosed herein execute the utility function(s) based on a payload of the data packet and/or based on historic information associated with the data stream. In some examples, based on a result of the execution of the utility function(s), examples disclosed herein determine the utility value corresponding to the data packet and, based on the utility value, determine whether to forward or drop the data packet. Advantageously, examples disclosed herein may reduce an amount of redundant and/or low utility data to be ingested at a platform, thus reducing an amount of computational resources and/or memory utilized to store and/or process incoming data.

Further examples disclosed herein preconfigure a plurality of proxy data streams for sending data between edge devices in a time-sensitive network environment. For example, examples disclosed herein preconfigure the proxy data streams to satisfy respective different communication metrics (e.g., bandwidth, latency, etc.) for data sent via the proxy data streams. In some examples, the proxy data streams are preconfigured based on expected QoS levels for one or more applications and/or operations associated with the edge device(s), and/or based on computational and/or communication resources available to the edge device(s). In some examples, example circuitry disclosed herein can select one of the proxy data streams that satisfies a target communication metric (e.g., a target QoS level, a target bandwidth and/or latency, etc.) for a first edge device, and can cause transmission of data from the first edge device to a second edge device based on the selected one of the proxy data streams. Further, the example circuitry can dynamically switch between ones of the proxy data streams to satisfy changing QoS demands for data transmitted to the second edge device.

In some examples, communication resources are preconfigured and/or pre-allocated to the respective proxy data streams as part of a handshake procedure between the edge device(s) and a central node (e.g., a centralized user configuration (CUC) node) of the time sensitive network environment. For example, the configuration of the proxy data streams can be performed once, and the configuration can be performed offline or in the background and before changes in QoS demand occur. Once configured, the example circuitry can switch between the proxy data streams without necessitating reallocation of the communication resources and/or recalculation of possible scheduling plans for data sent via the network. In some examples, because the proxy data streams and/or the scheduling plans are pre-computed, the circuitry can switch between ones of the proxy data streams with little or no signaling overhead. Accordingly, examples disclosed herein may reduce time and/or compute power used to adapt to changing QoS demands in the network. Advantageously, examples disclosed herein may satisfy the changing QoS demands without overprovisioning of the network.

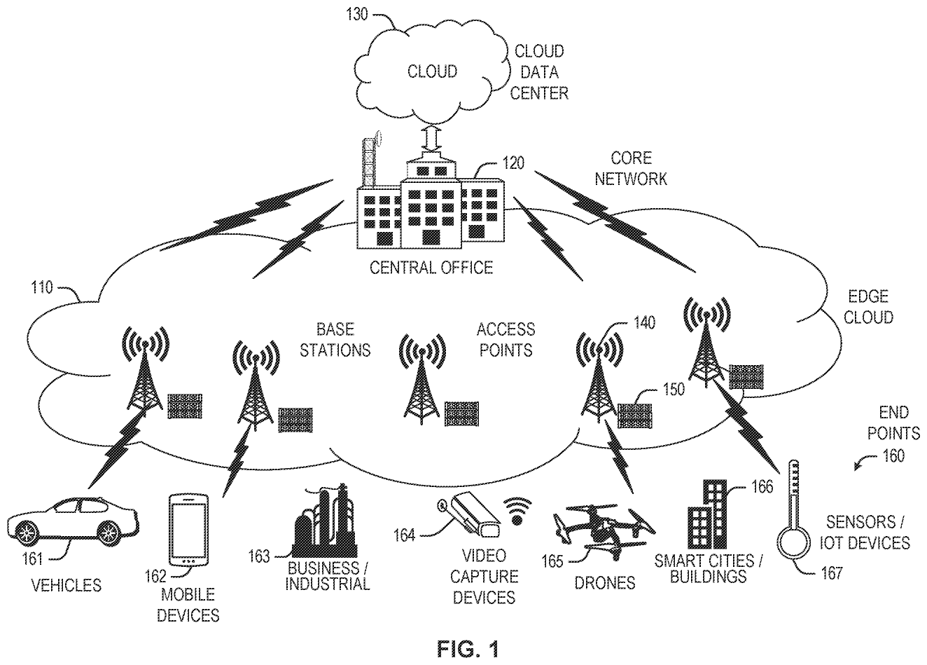

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

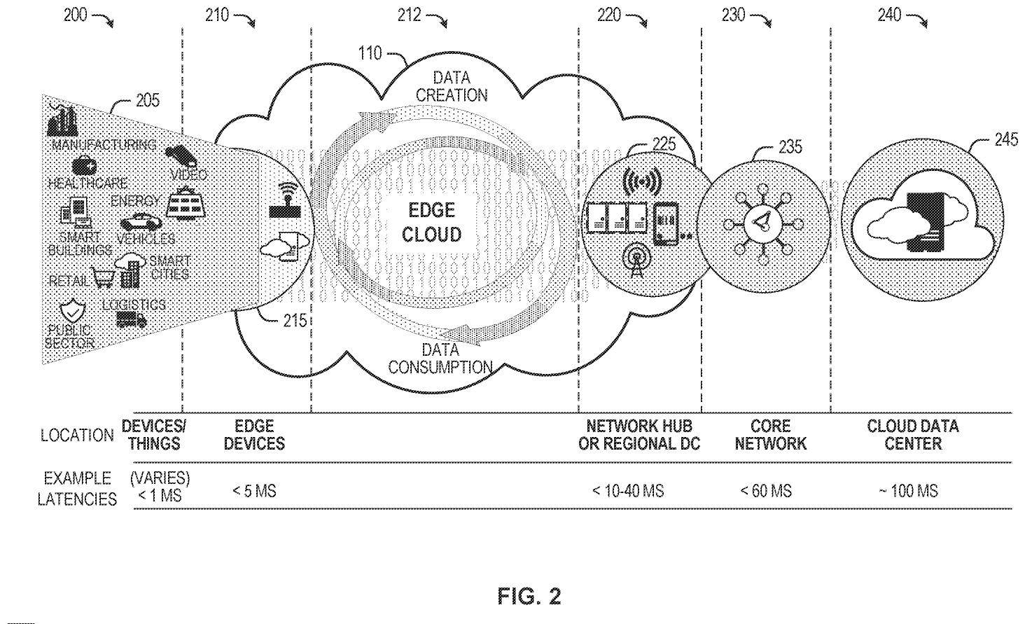

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement operations to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

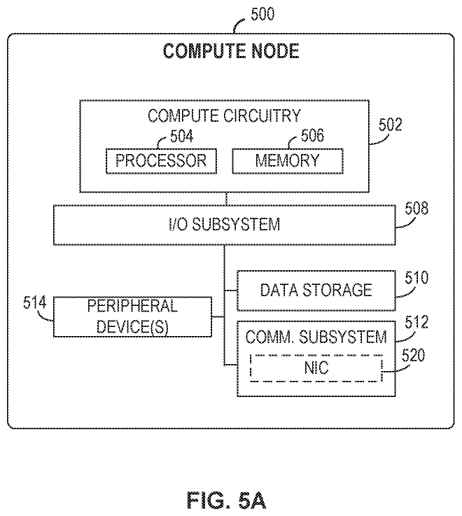

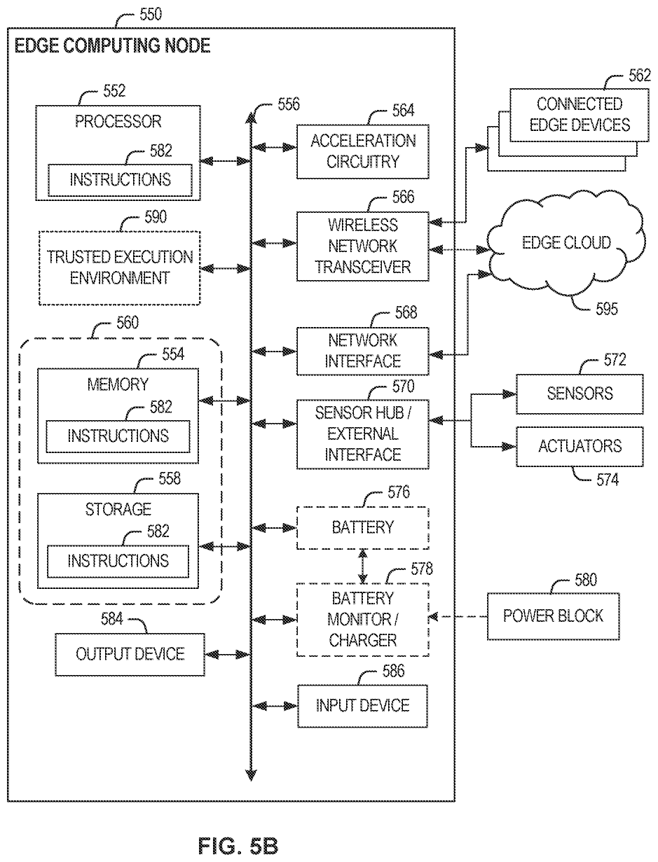

The network components of the edge cloud 110 may be servers, multi-tenant servers, appliance computing devices, and/or any other type of computing devices. For example, the edge cloud 110 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 5B. The edge cloud 110 may also include one or more servers and/or one or more multi-tenant servers. Such a server may include an operating system and a virtual computing environment. A virtual computing environment may include a hypervisor managing (spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

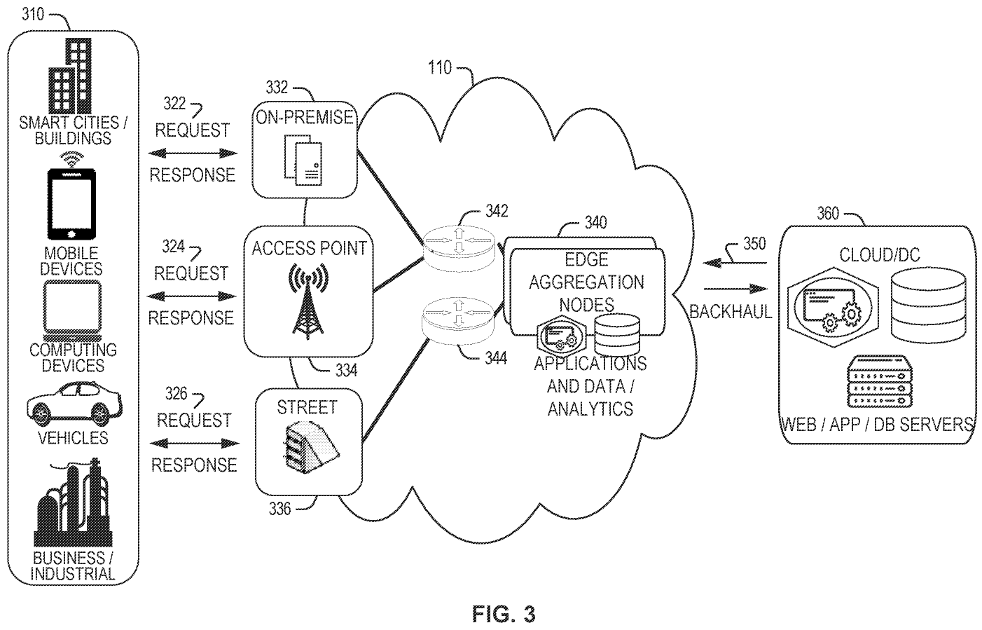

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

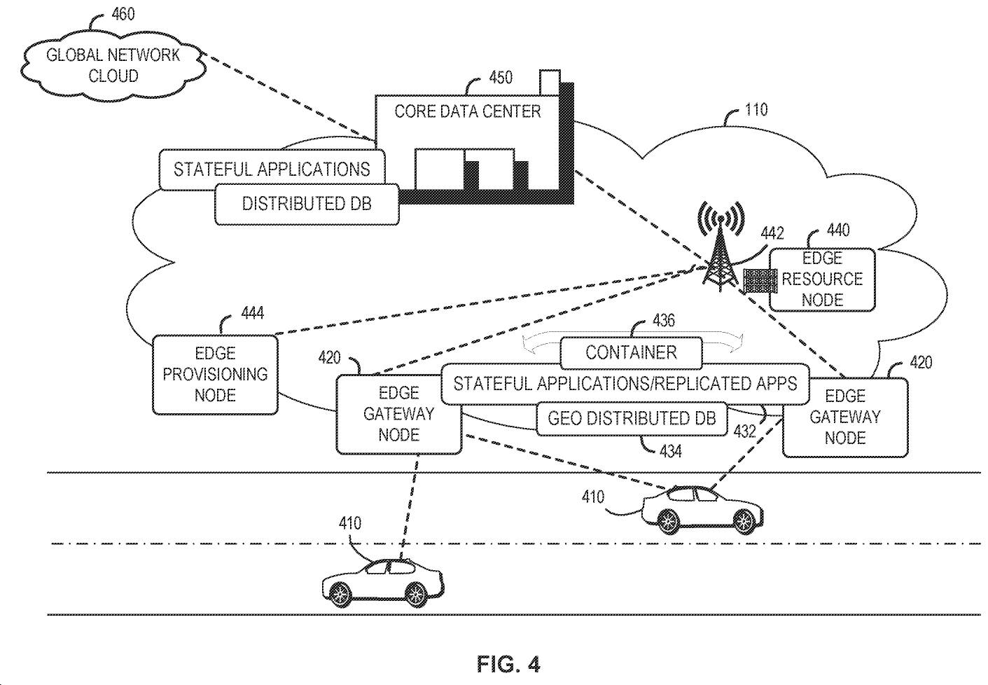

It should be appreciated that the edge computing systems and arrangements discussed herein may be applicable in various solutions, services, and/or use cases involving mobility. As an example, FIG. 4 shows a simplified vehicle compute and communication use case involving mobile access to applications in an edge computing system 400 that implements an edge cloud 110. In this use case, respective client compute nodes 410 may be embodied as in-vehicle compute systems (e.g., in-vehicle navigation and/or infotainment systems) located in corresponding vehicles which communicate with the edge gateway nodes 420 during traversal of a roadway. For instance, the edge gateway nodes 420 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 410 and a particular edge gateway device 420 may propagate so as to maintain a consistent connection and context for the client compute node 410. Likewise, mobile edge nodes may aggregate at the high priority services or according to the throughput or latency resolution requirements for the underlying service(s) (e.g., in the case of drones). The respective edge gateway devices 420 include an amount of processing and storage capabilities and, as such, some processing and/or storage of data for the client compute nodes 410 may be performed on one or more of the edge gateway devices 420.

The edge gateway devices 420 may communicate with one or more edge resource nodes 440, which are illustratively embodied as compute servers, appliances or components located at or in a communication base station 442 (e.g., a base station of a cellular network). As discussed above, the respective edge resource nodes 440 include an amount of processing and storage capabilities and, as such, some processing and/or storage of data for the client compute nodes 410 may be performed on the edge resource node 440. For example, the processing of data that is less urgent or important may be performed by the edge resource node 440, while the processing of data that is of a higher urgency or importance may be performed by the edge gateway devices 420 (depending on, for example, the capabilities of each component, or information in the request indicating urgency or importance). Based on data access, data location or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 440 also communicate with the core data center 450, which may include compute servers, appliances, and/or other components located in a central location (e.g., a central office of a cellular communication network). The core data center 450 may provide a gateway to the global network cloud 460 (e.g., the Internet) for the edge cloud 110 operations formed by the edge resource node(s) 440 and the edge gateway devices 420. Additionally, in some examples, the core data center 450 may include an amount of processing and storage capabilities and, as such, some processing and/or storage of data for the client compute devices may be performed on the core data center 450 (e.g., processing of low urgency or importance, or high complexity).

The edge gateway nodes 420 or the edge resource nodes 440 may offer the use of stateful applications 432 and a geographic distributed database 434. Although the applications 432 and database 434 are illustrated as being horizontally distributed at a layer of the edge cloud 110, it will be understood that resources, services, or other components of the application may be vertically distributed throughout the edge cloud (including, part of the application executed at the client compute node 410, other parts at the edge gateway nodes 420 or the edge resource nodes 440, etc.). Additionally, as stated previously, there can be peer relationships at any level to meet service objectives and obligations. Further, the data for a specific client or application can move from edge to edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a container 436 (or pod of containers) may be flexibly migrated from an edge node 420 to other edge nodes (e.g., 420, 640, etc.) such that the container with an application and workload does not need to be reconstituted, re-compiled, re-interpreted in order for migration to work. However, in such settings, there may be some remedial or “swizzling” translation operations applied. For example, the physical hardware at node 440 may differ from edge gateway node 420 and therefore, the hardware abstraction layer (HAL) that makes up the bottom edge of the container will be re-mapped to the physical layer of the target edge node. This may involve some form of late-binding technique, such as binary translation of the HAL from the container native format to the physical hardware format, or may involve mapping interfaces and operations. A pod controller may be used to drive the interface mapping as part of the container lifecycle, which includes migration to/from different hardware environments.

The scenarios encompassed by FIG. 4 may utilize various types of mobile edge nodes, such as an edge node hosted in a vehicle (car/truck/tram/train) or other mobile unit, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 420, some others at the edge resource node 440, and others in the core data center 450 or global network cloud 460.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code (e.g., an application which may be provided by a third party) is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, container is “spun down” (e.g., deactivated and/or deallocated) on the infrastructure in response to the execution being completed.

Further aspects of FaaS may enable deployment of edge functions in a service fashion, including a support of respective functions that support edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require initialization, deployment, or configuration).

The edge computing system 400 can include or be in communication with an edge provisioning node 444. The edge provisioning node 444 can distribute software such as the example computer readable instructions 582 of FIG. 5B, to various receiving parties for implementing any of the methods described herein. The example edge provisioning node 444 may be implemented by any computer server, home server, content delivery network, virtual server, software distribution system, central facility, storage device, storage node, data facility, cloud service, etc., capable of storing and/or transmitting software instructions (e.g., code, scripts, executable binaries, containers, packages, compressed files, and/or derivatives thereof) to other computing devices. Component(s) of the example edge provisioning node 644 may be located in a cloud, in a local area network, in an edge network, in a wide area network, on the Internet, and/or any other location communicatively coupled with the receiving party(ies). The receiving parties may be customers, clients, associates, users, etc. of the entity owning and/or operating the edge provisioning node 444. For example, the entity that owns and/or operates the edge provisioning node 444 may be a developer, a seller, and/or a licensor (or a customer and/or consumer thereof) of software instructions such as the example computer readable instructions 582 of FIG. 5B. The receiving parties may be consumers, service providers, users, retailers, OEMs, etc., who purchase and/or license the software instructions for use and/or re-sale and/or sub-licensing.

In an example, edge provisioning node 444 includes one or more servers and one or more storage devices. The storage devices host computer readable instructions such as the example computer readable instructions 582 of FIG. 5B, as described below. Similarly to edge gateway devices 420 described above, the one or more servers of the edge provisioning node 444 are in communication with a base station 442 or other network communication entity. In some examples, the one or more servers are responsive to requests to transmit the software instructions to a requesting party as part of a commercial transaction. Payment for the delivery, sale, and/or license of the software instructions may be handled by the one or more servers of the software distribution platform and/or via a third-party payment entity. The servers enable purchasers and/or licensors to download the computer readable instructions 582 from the edge provisioning node 444. For example, the software instructions, which may correspond to the example computer readable instructions 582 of FIG. 5B, may be downloaded to the example processor platform/s, which is to execute the computer readable instructions 582 to implement the methods described herein.

In some examples, the processor platform(s) that execute the computer readable instructions 582 can be physically located in different geographic locations, legal jurisdictions, etc. In some examples, one or more servers of the edge provisioning node 444 periodically offer, transmit, and/or force updates to the software instructions (e.g., the example computer readable instructions 582 of FIG. 5B) to ensure improvements, patches, updates, etc. are distributed and applied to the software instructions implemented at the end user devices. In some examples, different components of the computer readable instructions 582 can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

In further examples, any of the compute nodes or devices discussed with reference to the present edge computing systems and environment may be fulfilled based on the components depicted in FIGS. 5A and 5B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 5A, an edge compute node 500 includes a compute engine (also referred to herein as “compute circuitry”) 502, an input/output (I/O) subsystem 508, data storage 510, a communication circuitry subsystem 512, and, optionally, one or more peripheral devices 514. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 500 may be embodied as any type of engine, device, or collection of devices capable of performing various compute functions. In some examples, the compute node 500 may be embodied as a single device such as an integrated circuit, an embedded system, a field-programmable gate array (FPGA), a system-on-a-chip (SOC), or other integrated system or device. In the illustrative example, the compute node 500 includes or is embodied as a processor 504 and a memory 506. The processor 504 may be embodied as any type of processor capable of performing the functions described herein (e.g., executing an application). For example, the processor 504 may be embodied as a multi-core processor(s), a microcontroller, a processing unit, a specialized or special purpose processing unit, or other processor or processing/controlling circuit.

In some examples, the processor 504 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 504 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 504 may work in coordination with each other to execute many types of operations and instructions within and on behalf of the compute node 500.

The memory 506 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 506 may be integrated into the processor 504. The memory 506 may store various software and data used during operation such as one or more applications, data operated on by the application(s), libraries, and drivers.

The compute circuitry 502 is communicatively coupled to other components of the compute node 500 via the I/O subsystem 508, which may be embodied as circuitry and/or components to facilitate input/output operations with the compute circuitry 502 (e.g., with the processor 504 and/or the main memory 506) and other components of the compute circuitry 502. For example, the I/O subsystem 508 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 508 may form a portion of a system-on-a-chip (SoC) and be incorporated, along with one or more of the processor 504, the memory 506, and other components of the compute circuitry 502, into the compute circuitry 502.

The one or more illustrative data storage devices 510 may be embodied as any type of devices configured for short-term or long-term storage of data such as, for example, memory devices and circuits, memory cards, hard disk drives, solid-state drives, or other data storage devices. Individual data storage devices 510 may include a system partition that stores data and firmware code for the data storage device 510. Individual data storage devices 510 may also include one or more operating system partitions that store data files and executables for operating systems depending on, for example, the type of compute node 500.

The communication circuitry 512 may be embodied as any communication circuit, device, or collection thereof, capable of enabling communications over a network between the compute circuitry 502 and another compute device (e.g., an edge gateway of an implementing edge computing system). The communication circuitry 512 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 512 includes a network interface controller (NIC) 520, which may also be referred to as a host fabric interface (HFI). The NIC 520 may be embodied as one or more add-in-boards, daughter cards, network interface cards, controller chips, chipsets, or other devices that may be used by the compute node 500 to connect with another compute device (e.g., an edge gateway node). In some examples, the NIC 520 may be embodied as part of a system-on-a-chip (SoC) that includes one or more processors, or included on a multichip package that also contains one or more processors. In some examples, the NIC 520 may include a local processor (not shown) and/or a local memory (not shown) that are both local to the NIC 520. In such examples, the local processor of the NIC 520 may be capable of performing one or more of the functions of the compute circuitry 502 described herein. Additionally, or alternatively, in such examples, the local memory of the NIC 520 may be integrated into one or more components of the client compute node at the board level, socket level, chip level, and/or other levels.

Additionally, in some examples, a respective compute node 500 may include one or more peripheral devices 514. Such peripheral devices 514 may include any type of peripheral device found in a compute device or server such as audio input devices, a display, other input/output devices, interface devices, and/or other peripheral devices, depending on the particular type of the compute node 500. In further examples, the compute node 500 may be embodied by a respective edge compute node (whether a client, gateway, or aggregation node) in an edge computing system or like forms of appliances, computers, subsystems, circuitry, or other components.

In a more detailed example, FIG. 5B illustrates a block diagram of an example of components that may be present in an edge computing node 550 for implementing the techniques (e.g., operations, processes, methods, and methodologies) described herein. This edge computing node 550 provides a closer view of the respective components of node 500 when implemented as or as part of a computing device (e.g., as a mobile device, a base station, server, gateway, etc.). The edge computing node 550 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 550, or as components otherwise incorporated within a chassis of a larger system.

The edge computing device 550 may include processing circuitry in the form of a processor 552, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 552 may be a part of a system on a chip (SoC) in which the processor 552 and other components are formed into a single integrated circuit, or a single package, such as the Edison™ or Galileo™ SoC boards from Intel Corporation, Santa Clara, California. As an example, the processor 552 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, California, a MIPS®-based design from MIPS Technologies, Inc. of Sunnyvale, California, an ARM®-based design licensed from ARM Holdings, Ltd. or a customer thereof, or their licensees or adopters. The processors may include units such as an A5-13 processor from Apple® Inc., a Snapdragon™ processor from Qualcomm® Technologies, Inc., or an OMAP™ processor from Texas Instruments, Inc. The processor 552 and accompanying circuitry may be provided in a single socket form factor, multiple socket form factor, or a variety of other formats, including in limited hardware configurations or configurations that include fewer than all elements shown in FIG. 5B.

The processor 552 may communicate with a system memory 554 over an interconnect 556 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 558 may also couple to the processor 552 via the interconnect 556. In an example, the storage 558 may be implemented via a solid-state disk drive (SSDD). Other devices that may be used for the storage 558 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 558 may be on-die memory or registers associated with the processor 552. However, in some examples, the storage 558 may be implemented using a micro hard disk drive (HDD). Further, any number of new technologies may be used for the storage 558 in addition to, or instead of, the technologies described, such resistance change memories, phase change memories, holographic memories, or chemical memories, among others.

The components may communicate over the interconnect 556. The interconnect 556 may include any number of technologies, including industry standard architecture (ISA), extended ISA (EISA), peripheral component interconnect (PCI), peripheral component interconnect extended (PCIx), PCI express (PCIe), or any number of other technologies. The interconnect 556 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 556 may couple the processor 552 to a transceiver 566, for communications with the connected edge devices 562. The transceiver 566 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 562. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 566 (or multiple transceivers) may communicate using multiple standards or radios for communications at a different range. For example, the edge computing node 550 may communicate with close devices, e.g., within about 10 meters, using a local transceiver based on Bluetooth Low Energy (BLE), or another low power radio, to save power. More distant connected edge devices 562, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 566 (e.g., a radio transceiver) may be included to communicate with devices or services in a cloud (e.g., an edge cloud 595) via local or wide area network protocols. The wireless network transceiver 566 may be a low-power wide-area (LPWA) transceiver that follows the IEEE 802.15.4, or IEEE 802.15.4g standards, among others. The edge computing node 550 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 566, as described herein. For example, the transceiver 566 may include a cellular transceiver that uses spread spectrum (SPA/SAS) communications for implementing high-speed communications. Further, any number of other protocols may be used, such as Wi-Fi® networks for medium speed communications and provision of network communications. The transceiver 566 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 568 may be included to provide a wired communication to nodes of the edge cloud 595 or to other devices, such as the connected edge devices 562 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 568 may be included to enable connecting to a second network, for example, a first NIC 568 providing communications to the cloud over Ethernet, and a second NIC 568 providing communications to other devices over another type of network.

Given the variety of types of applicable communications from the device to another component or network, applicable communications circuitry used by the device may include or be embodied by any one or more of components 564, 566, 568, or 570. Accordingly, in various examples, applicable means for communicating (e.g., receiving, transmitting, etc.) may be embodied by such communications circuitry.

The edge computing node 550 may include or be coupled to acceleration circuitry 564, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 556 may couple the processor 552 to a sensor hub or external interface 570 that is used to connect additional devices or subsystems. The devices may include sensors 572, such as accelerometers, level sensors, flow sensors, optical light sensors, camera sensors, temperature sensors, global navigation system (e.g., GPS) sensors, pressure sensors, barometric pressure sensors, and the like. The hub or interface 570 further may be used to connect the edge computing node 550 to actuators 574, such as power switches, valve actuators, an audible sound generator, a visual warning device, and the like.

In some optional examples, various input/output (I/O) devices may be present within or connected to, the edge computing node 550. For example, a display or other output device 584 may be included to show information, such as sensor readings or actuator position. An input device 586, such as a touch screen or keypad may be included to accept input. An output device 584 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 550. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 576 may power the edge computing node 550, although, in examples in which the edge computing node 550 is mounted in a fixed location, it may have a power supply coupled to an electrical grid, or the battery may be used as a backup or for temporary capabilities. The battery 576 may be a lithium ion battery, or a metal-air battery, such as a zinc-air battery, an aluminum-air battery, a lithium-air battery, and the like.

A battery monitor/charger 578 may be included in the edge computing node 550 to track the state of charge (SoCh) of the battery 576, if included. The battery monitor/charger 578 may be used to monitor other parameters of the battery 576 to provide failure predictions, such as the state of health (SoH) and the state of function (SoF) of the battery 576. The battery monitor/charger 578 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 578 may communicate the information on the battery 576 to the processor 552 over the interconnect 556. The battery monitor/charger 578 may also include an analog-to-digital (ADC) converter that enables the processor 552 to directly monitor the voltage of the battery 576 or the current flow from the battery 576. The battery parameters may be used to determine actions that the edge computing node 550 may perform, such as transmission frequency, mesh network operation, sensing frequency, and the like.

A power block 580, or other power supply coupled to a grid, may be coupled with the battery monitor/charger 578 to charge the battery 576. In some examples, the power block 580 may be replaced with a wireless power receiver to obtain the power wirelessly, for example, through a loop antenna in the edge computing node 550. A wireless battery charging circuit, such as an LTC4020 chip from Linear Technologies of Milpitas, California, among others, may be included in the battery monitor/charger 578. The specific charging circuits may be selected based on the size of the battery 576, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 558 may include instructions 582 in the form of software, firmware, or hardware commands to implement the techniques described herein. Although such instructions 582 are shown as code blocks included in the memory 554 and the storage 558, it may be understood that any of the code blocks may be replaced with hardwired circuits, for example, built into an application specific integrated circuit (ASIC).

In an example, the instructions 582 provided via the memory 554, the storage 558, or the processor 552 may be embodied as a non-transitory, machine-readable medium 560 including code to direct the processor 552 to perform electronic operations in the edge computing node 550. The processor 552 may access the non-transitory, machine-readable medium 560 over the interconnect 556. For instance, the non-transitory, machine-readable medium 560 may be embodied by devices described for the storage 558 or may include specific storage units such as optical disks, flash drives, or any number of other hardware devices. The non-transitory, machine-readable medium 560 may include instructions to direct the processor 552 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 582 on the processor 552 (separately, or in combination with the instructions 582 of the machine readable medium 560) may configure execution or operation of a trusted execution environment (TEE) 590. In an example, the TEE 590 operates as a protected area accessible to the processor 552 for secure execution of instructions and secure access to data. Various implementations of the TEE 590, and an accompanying secure area in the processor 552 or the memory 554 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 550 through the TEE 590 and the processor 552.

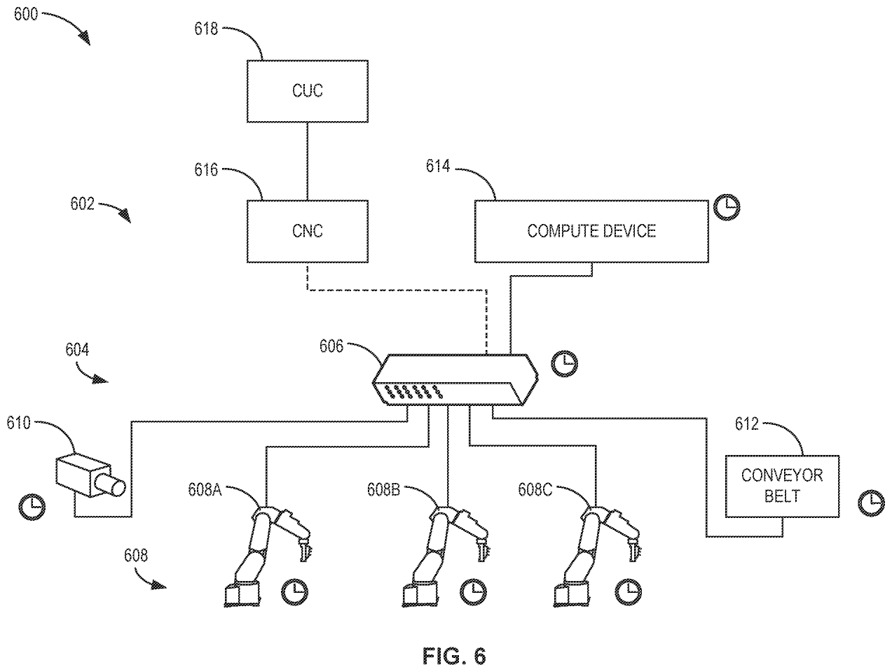

FIG. 6 illustrates an example cluster (e.g., a node cluster, a device cluster) 602 implemented in an example time sensitive network (TSN) environment 600. In the illustrated example of FIG. 6, the cluster 602 includes example devices (e.g., end point devices, user equipment) 604 communicatively coupled to an example bridge (e.g., a TSN bridge) 606. In this example, the devices 604 include example robot arms 608 (e.g., a first example robot arm 608A, a second example robot arm 608B, and a third example robot arm 608C), an example camera 610, and an example conveyor belt 612, where the devices 604 operate together to perform an example assembly procedure. In the illustrated example, an example compute device (e.g., a TSN end device, an edge compute server, an edge compute node) 614 is communicatively coupled to one(s) of the devices 604 via the bridge 606 to obtain data from and/or send data to the one(s) of the devices 604. Further, an example centralized network configuration (CNC) node (e.g., a CNC device, a central node) 616 is communicatively coupled to the bridge 606 and further coupled to an example centralized user configuration (CUC) node (e.g., a CUC device) 618. In this example, each of the devices 604, the bridge 606, and the compute device 614 are time-synchronized (e.g., example clocks associated with the respective ones of the devices 604, the bridge 606, and/or the compute device 614 are synchronized).

In the illustrated example of FIG. 6, the compute device 614 can control, obtain data from, and/or provide data to one(s) of the device 604 using example TSN infrastructure of the TSN environment 600. For example, example image data (e.g., video stream data) from the camera 610 and/or example position data from one(s) of the robot arms 608 and/or the conveyor belt 612 can be provided to the compute device 614. In some examples, expected communication metrics (e.g., expected quality of service (QoS) metrics, expected QoS levels) for the data sent from the one(s) of the devices 604 can vary over time. In some examples, the communication metrics include bandwidth utilization, latency, video stream resolution, video compression scheme, etc.

In some examples, during the example assembly procedure of FIG. 6, an example object positioned on the conveyor belt 612 can be moved along the conveyor belt 612 relative to the robot arms 608. In some examples, the robot arms 608 perform respective example operations (e.g., picking up and/or rotating the object, adding and/or removing a component of the object, etc.) when the object passes by the respective robot arms 608. In some examples, to enable one or more of the robot arms 608 to perform the respective operation(s), image data (e.g., video data) from the camera 610 is sent to an example edge device (e.g., an edge compute device) communicatively coupled to the example compute device 614. For example, the edge device can process the image data to perform object detection and/or to adjust positions of one(s) the robot arms 608 to perform the respective operation(s). In some examples, the edge device can return the result of the image data processing to the compute device 614 for use in controlling and/or adjusting the one(s) of the robot arms 608.

In some examples, based on the distances between the object and the respective robot arms 608, the devices 604 may be in different example states (e.g., states of operation, states of use, use cases) corresponding to different expected communication metrics. For example, first one(s) of the robot arms 608 that are within a threshold distance of the object can perform one or more operations on the objects, while second one(s) of the robot arms 608 that are further from the object (e.g., more than the threshold distance away from the object) may remain idle. In such examples, the expected communication metrics for the first one(s) of the robot arms 608 that are operational may be different (e.g., lower latency, greater bandwidth utilization, higher video resolution, etc.) compared to the expected communication metrics for the second one(s) of the robot arms 608 that are idle to enable efficient utilization of available communication resources while maintaining precise control of the robot arms 608. For example, the edge device may require lower latency and/or utilize a full resolution of video data from the camera 610 to perform object detection and/or control the first one(s) of the robot arms 608, while the edge device may have more lenient latency requirements for the video data and/or the video data can be more severely compressed when the edge device is to control the second one(s) of the robot arms 608.

In some examples, the CNC node 616 receives one or more example requests from the CUC node 618 and/or from one other more other CUC nodes in the TSN environment 600. In some examples, based on the request(s), the CNC node allocates computing resources to one or more example nodes (e.g., the CUC nodes, the compute device 614, etc.) in the TSN environment 600. In some examples, to adjust and/or reallocate the computing resources for one(s) of the nodes (e.g., as a result of a change in state of the node(s)), one or more additional request(s) are sent to the CNC node 616 indicating, for example, a desired bandwidth for the one(s) of the nodes. In some examples, the CNC node 616 reallocates and/or reconfigures the computing resources based on the desired bandwidth. However, such reconfiguration and/or reallocation by the CNC node 616 can result in delays (e.g., up to a few tenths of a millisecond) that can reduce speed and/or increase latency of communication in the TSN environment 600.

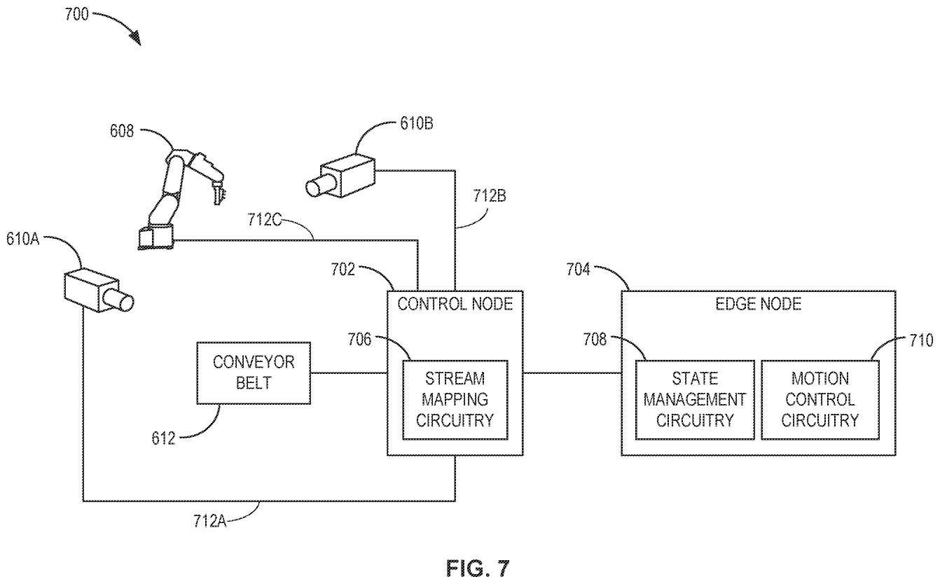

FIG. 7 illustrates an example system 700 that can be implemented in the example TSN environment 600 of FIG. 6. In the illustrated example of FIG. 7, the system 700 includes an example control node (e.g., a control device) 702 communicatively coupled to an example edge node (e.g., an edge device, an edge compute device) 704, where the control node 702 implements example stream mapping circuitry 706 and the edge node 704 implements example state management circuitry 708 and example motion control circuitry 710 in accordance with teachings of this disclosure. In some examples, the control node 702 corresponds to a router and/or an in-edge server of an example TSN environment. In some examples, the control node 702 corresponds to the example compute device 614 of FIG. 6. In some examples, the edge node 704 corresponds to an edge server and/or an edge server system of the TSN environment. In the illustrated example, the control node 702 is communicatively coupled to one of the example robot arms 608, a first example camera 610A, a second example camera 610B, and the conveyor belt 612.

In some examples, multiple instances of the control node 702 and/or the stream mapping circuitry 706 can be used, such that one(s) of the devices 604 in FIG. 7 implement respective instances of the control node 702 and/or the stream mapping circuitry 706 therein. In the illustrated example, the state management circuitry 708 and the motion control circuitry 710 are implemented in the same edge node 704. However, the state management circuitry 708 and the motion control circuitry 710 can be implemented in different nodes in some examples.

In the illustrated example of FIG. 7, the control node 702 obtains data streams from and/or controls operation of one(s) of the devices 604 (e.g., the robot arm 608, the camera(s) 610, and/or the conveyor belt 612). For example, the cameras 610A, 610B can provide respective example image data streams (e.g., video streams) 712A, 712B to the control node 702, where the image data streams 712A, 712B include example frames (e.g., video frames, camera frames) representative of a scene from respective viewpoints of the cameras 610A, 610B. In the illustrated example, the robot arm 608 provides an example position data stream 712C to the control node 702, where the position data stream 712C represents example positions of the robot arm 608. In some examples, one or more additional data streams from one(s) of the devices 604 of FIG. 6 can additionally or alternatively be provided to the example control node 702 of FIG. 7.

In some examples, because the control node 702 is located closer to an endpoint (e.g., the devices 604) of the TSN environment 600 (e.g., compared to the edge node 704), the control node 702 may have fewer processing and/or compute resources compared to the edge node 704. As a result, for some computationally-intensive tasks (e.g., state estimation and/or motion control for one(s) of the devices 604), the control node 702 provides one(s) of the data streams 712 to the edge node 704 for processing. In the illustrated example of FIG. 7, the data streams 712 are provided to the edge node 704 using one or more example proxy data streams (e.g., proxy channels), where the proxy data streams are defined between example proxy talkers implemented at the control node 702 and corresponding listeners implemented at the edge node 704. In examples disclosed herein, proxy data streams correspond to reserved communication resources of the control node 702 and/or the edge node 704, where the reserved communication resources are preconfigured to satisfy respective different communication metrics (e.g., QoS metrics.). In some examples, the communication resources reserved for different ones of the proxy data streams enable sending of data at respective different bandwidths, latencies, speeds, etc. For example, a first proxy data stream can send data at a first example QoS level (e.g., a first bandwidth, a first latency, and/or a first speed), while a second proxy data stream can send the data at a second example QoS level (e.g., a second bandwidth, a second latency, a second speed, etc.) different from the first QoS level.

In the illustrated example of FIG. 7, the example stream mapping circuitry 706 selects one(s) of the proxy data streams for sending data (e.g., the data stream(s) 712) from the control node 702 to the edge node 704. For example, the stream mapping circuitry 706 maps and/or allocates the data stream(s) 712 received at the control node 702 to respective one(s) of the proxy data streams. In some examples, the stream mapping circuitry 706 selects the proxy data stream(s) based on a default mapping (e.g., a default configuration) stored in the stream mapping circuitry 706. In some examples, the stream mapping circuitry 706 selects and/or adjusts the mapping of the data stream(s) 712 to one(s) of the proxy data streams based on example state information from the example state management circuitry 708 of the edge node 704.

For example, the state management circuitry 708 determines the state information for the control node 702 and/or for one(s) of the devices 604 based on data provided to the edge node 704 via one(s) of the proxy data streams. In some examples, the state management circuitry 708 determines, based on image data from the image data streams 712A, 712B obtained via first one(s) of the proxy data streams, example distance(s) between an object on the conveyor belt 612 and the robot arm 608. Additionally or alternatively, the state management circuitry 708 can determine current position(s) of the robot arm 608 based on the position data stream 712C obtained via second one(s) of the proxy data streams. In some examples, the state management circuitry 708 provides the determined distance(s) and/or positions as state information to the stream mapping circuitry 706.

In some examples, based on the data obtained via the proxy data stream(s) and/or based on the state information determined by the state management circuitry 708, the motion control circuitry 710 determines example control information for controlling one(s) of the devices 604. For example, the motion control circuitry 710 determines, based on the current position of the robot arm 608 and/or based on the distance between the object and the robot arm 608, one or more target positions and/or target movements for the robot arm 608 to perform an operation (e.g., grasp the object, add and/or remove a component from the object, etc.). In some examples, the motion control circuitry 710 provides the control information to the control node 702 for use in controlling the one(s) of the devices 604, where the control information includes the target positions and/or the target movements.

In some examples, based on the state information from the state management circuitry 708, the stream mapping circuitry 706 determines and/or selects target communication metrics (e.g., target QoS levels) for one(s) of the data streams 712. For example, when the state information indicates that the distance between the object and the robot arm 608 is less than a threshold distance and/or the robot arm 608 is to perform a grasping operation, the stream mapping circuitry 706 adjusts the target communication metric(s) for the position data stream 712C (e.g., increases a target bandwidth for the position data stream 712C, reduces a target latency for the position data stream 712C, etc.). In such examples, the stream mapping circuitry 706 adjusts the mapping between the data streams 712 and the proxy data streams such that the image data stream 712C is reallocated to one(s) of the data streams satisfying the target communication metric(s). In some examples, the stream mapping circuitry 706 evaluates and/or adjusts the mapping periodically and/or in response to obtaining new state information from the state management circuitry 708.

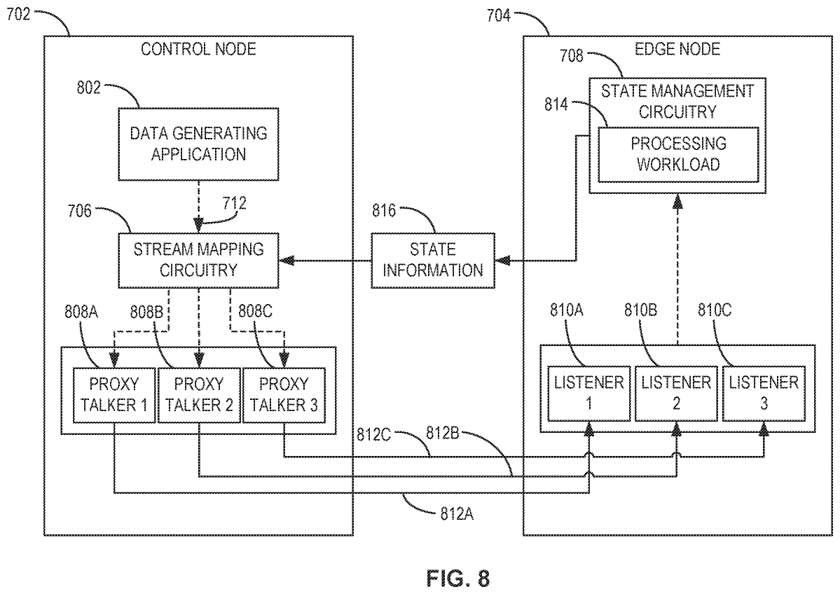

FIG. 8 illustrates example implementations of the example control node 702 and the example edge node 704 of FIG. 7. In the illustrated example of FIG. 8, the control node 702 implements the example stream mapping circuitry 706, which obtains an example data stream 712 (e.g., one(s) of the image data streams 712A, 712B and/or the position data stream 712C) from an example data generation application 802 associated with one(s) of the devices 604 of FIGS. 6 and/or 7. In the illustrated example of FIG. 8, the control node 702 implements multiple example proxy talkers 808 (e.g., including a first example proxy talker 808A, a second example proxy talker 808B, and a third example proxy talker 808C) communicatively coupled to respective example listeners 810 (e.g., a first example listener 810A, a second example listener 810B, and a third example listener 810C) implemented at the edge node 704. In this example, example proxy data streams (e.g., proxy data channels) 812 are defined between respective pairs of the proxy talkers 808 and the corresponding listeners 810.

In the illustrated example of FIG. 8, the proxy data streams 812 correspond to respective different communication metrics (e.g., respective different QoS levels.). For example, the first proxy data stream 812A corresponds to a first example latency (e.g., less than 1 millisecond of latency), the second proxy data stream 812B corresponds to a second example latency (e.g., less than 20 milliseconds of latency), and the third proxy data stream 812C corresponds to a third example latency (e.g., greater than 20 milliseconds of latency). While the communication metrics correspond to latency (e.g., latency in data transmission) in this example, different communication metrics (e.g., related to bandwidth, speed, etc.) along one(s) of the proxy data streams 812 can additionally or alternatively be used.

In some examples, the proxy data streams 812 are preconfigured by the example CNC node 616 of FIG. 6 as part of a handshake procedure (e.g., a connection handshake, an exchange of network communications) that establishes example communication link(s) between the control node 702 and the CNC node 616. For example, the stream mapping circuitry 706 evaluates communication resources available to the control node 702 to determine possible QoS metrics (e.g., possible latencies and/or bandwidths, etc.) that can be provided and/or supported by the communication resources. In such examples, as part of the handshake with the CNC node 616, the stream mapping circuitry 706 generates an array (e.g., a list, a QoS array) of the possible QoS metrics corresponding to the communication resources, and provides the array to the CNC node 616. In some examples, the CNC node 616 determines multiple (e.g., all) possible combinations and/or permutations of the QoS metrics represented in the array, and the CNC node 616 selects and/or determines the proxy data streams 812 corresponding to different one(s) of the combinations and/or permutations.

In some examples, the CNC node 616 provides example configuration information to the control node 702. In some examples, the configuration information indicates a number of the proxy data streams 812 to be preconfigured, example indices (e.g., identifiers) corresponding to the proxy data streams 812, latencies associated with one(s) of the proxy data streams 812, bandwidth allocated to the one(s) of the proxy data streams 812, etc. In some examples, based on the configuration information, the stream mapping circuitry 706 allocates (e.g., reserves, assigns, etc.) the communication resources to respective one(s) of the proxy data streams 812. By preconfiguring and/or preallocating the communication resources to the respective proxy data streams 812 satisfying respective different QoS metrics, the stream mapping circuitry 706 can dynamically switch between one(s) of the proxy data streams 812 to satisfy changing QoS requirements for data to be sent to the edge node 704. For example, the stream mapping circuitry 706 can switch between the preconfigured proxy data streams 812 without necessitating reallocation of the communication resources by the CNC node 616, thus reducing time and/or compute power utilized to adapt to different QoS levels.

In some examples, the stream mapping circuitry 706 selects one(s) of the proxy data streams 812 and/or the associated proxy talkers 808 to provide data from the data stream 712 to the edge node 704. For example, the stream mapping circuitry 706 selects the one(s) of the proxy data streams 812 based on an expected QoS for the data stream 712 and/or based on an example default mapping. In this example, based on the default mapping, the stream mapping circuitry 706 selects the third proxy data stream 812C (e.g., corresponding to a lowest QoS level and/or a highest latency among the proxy data streams 812) to send data from the data stream 712 to the edge node 704. In some examples, a different one of the proxy data streams 812 (e.g., the first proxy data stream corresponding to the highest QoS level and/or the lowest latency among the proxy data streams 812, etc.) can be selected based on the default mapping. In this example, in response to selecting the third proxy data stream 812C, the stream mapping circuitry 706 utilizes communication resources allocated to the third proxy talker 808C to send the data via the third proxy data stream 812C to the corresponding third listener 810C at the edge node 704. In such examples, the communication resources corresponding to remaining one(s) of the proxy data streams 812 (e.g., the first proxy data stream 812A and/or the second proxy data stream 812B) can be utilized for other network communications (e.g., other data streams to be sent to the edge node 704).

In the illustrated example of FIG. 8, after receipt by the third listener 810C, the data provided via the third proxy data stream 812C is provided to an example processing workload 814 of the state management circuitry 708. In this example, the state management circuitry 708 generates example state information 816 based on the data. In some examples, the state information 816 represents positions and/or orientations of the device(s) 604 associated with the data stream 712, distance(s) between the device(s) 604 and one or more objects, etc. For example, when the data includes one or more images captured by one(s) of the camera 610 of FIG. 7, the state management circuitry 708 performs image processing of the image(s) to detect the object(s) positioned on the conveyor belt 612 of FIG. 7 and/or determines the distance(s) between the device(s) 604 and the object(s). In some examples, the state information 816 represents a state of use case (e.g., an operational state) of the device(s) 604 (e.g., whether the robot arm 608 of FIG. 7 is idle or is performing a grasping operation, etc.). In some examples, the state management circuitry 708 provides the state information 816 to the stream mapping circuitry 706.

In some examples, based on the state information 816, the stream mapping circuitry 706 adjusts the mapping between the data stream 712 and the proxy data streams 812. For example, the stream mapping circuitry 706 determines a target communication metric (e.g., a target QoS level, a target bandwidth, a target latency, etc.) corresponding to the data stream 712 based on the state information 816. In this example, the stream mapping circuitry 706 can determine, based on the state information 816, that an object on the conveyor belt 612 is approaching the device(s) 604 producing the data stream 712 (e.g., a distance between the device(s) 604 and the object is decreasing and/or is less than a threshold distance). In some such examples, the stream mapping circuitry 706 determines that the target latency for the data stream 712 is to decrease. As a result, the stream mapping circuitry 706 switches the mapping of the data stream 712 from the third proxy data stream 812C to one of the first proxy data stream 812A or the second proxy data stream 812B having reduced latency compared to the third proxy data stream 812C. In some such examples, the communication resources associated with remaining ones of the proxy data streams 812 (e.g., the third proxy data stream 812C and the unselected one of the first proxy data stream 812A or the second proxy data stream 812B) can be utilized for other communication tasks and/or data streams, thus enabling efficient utilization of the communication resources at the control node 702. Advantageously, the stream mapping circuitry 706 can adjust the mapping of the data stream 712 between ones of the proxy data streams 812 without sending a request to the CNC node 616 of FIG. 6 to recalculate and/or reconfigure the allocation of resources at the control node 702, thereby reducing time and/or computational power required to adjust the mapping.

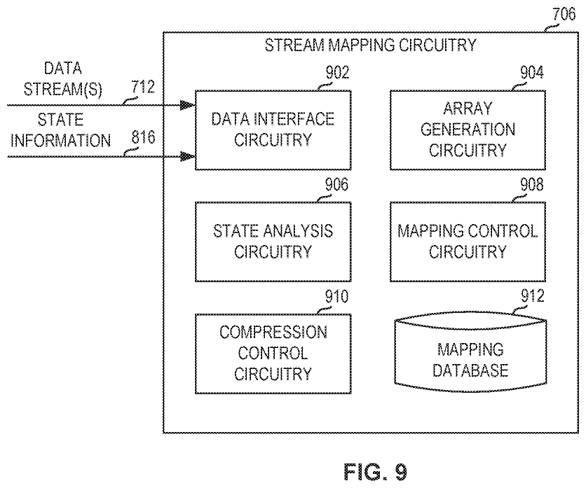

FIG. 9 is a block diagram of an example implementation of the example stream mapping circuitry 706 of FIGS. 7 and/or 8. The stream mapping circuitry 706 of FIG. 9 may be instantiated (e.g., creating an instance of, bring into being for any length of time, materialize, implement, etc.) by programmable circuitry such as a Central Processor Unit (CPU) executing first instructions. Additionally or alternatively, the stream mapping circuitry 706 of FIG. 9 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 9 may, thus, be instantiated at the same or different times. Some or all of the circuitry of FIG. 9 may be instantiated, for example, in one or more threads executing concurrently on hardware and/or in series on hardware. Moreover, in some examples, some or all of the circuitry of FIG. 9 may be implemented by microprocessor circuitry executing instructions and/or FPGA circuitry performing operations to implement one or more virtual machines and/or containers.

In the illustrated example of FIG. 9, the stream mapping circuitry 706 includes example data interface circuitry 902, example array generation circuitry 904, example state analysis circuitry 906, example mapping control circuitry 908, example compression control circuitry 910, and an example mapping database 912.

The example mapping database 912 stores data utilized and/or obtained by the stream mapping circuitry 706. The example mapping database 912 of FIG. 9 is implemented by any memory, storage device and/or storage disc for storing data such as, for example, flash memory, magnetic media, optical media, solid state memory, hard drive(s), thumb drive(s), etc. Furthermore, the data stored in the example mapping database 912 may be in any data format such as, for example, binary data, comma delimited data, tab delimited data, structured query language (SQL) structures, etc. While, in the illustrated example, the example mapping database 912 is illustrated as a single device, the example mapping database 912 and/or any other data storage devices described herein may be implemented by any number and/or type(s) of memories.

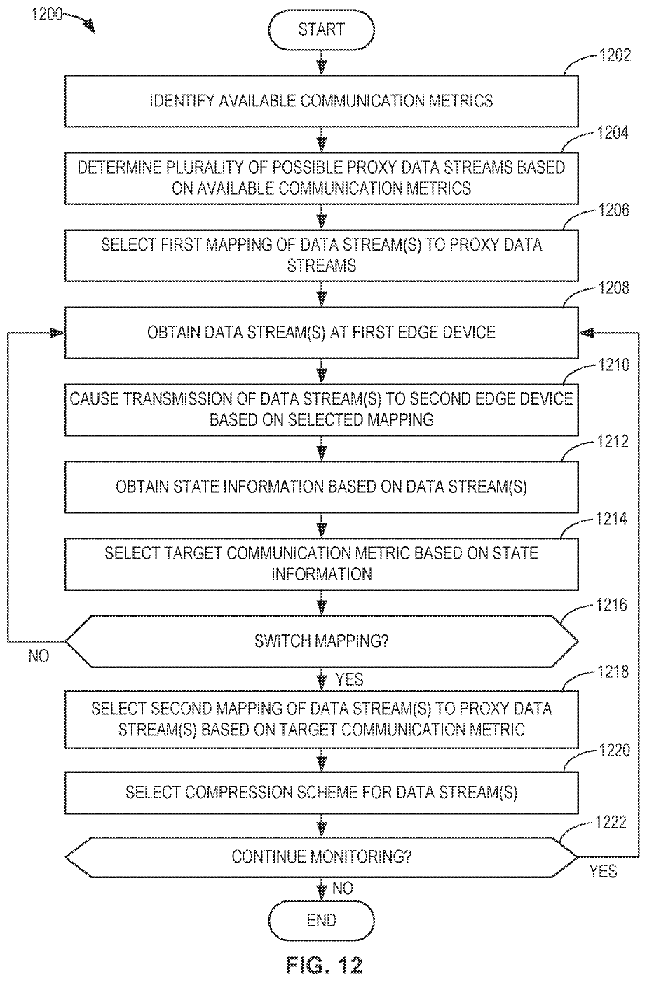

The example data interface circuitry 902 of FIG. 9 accesses and/or obtains example data to be utilized by the stream mapping circuitry 706. For example, the data interface circuitry 902 accesses one or more of the example data streams 712 produced and/or generated by one or more of the example devices 604 of FIGS. 6 and/or 7. In some examples, the data stream(s) 712 include one or more of image data streams (e.g., the image data streams 712A, 712B of FIG. 7) from one(s) of the cameras 610 and/or include one or more position data streams (e.g., the position data streams 712C of FIG. 7) from one(s) of the robot arms 608 of FIGS. 6 and/or 7. In the illustrated example of FIG. 9, the data interface circuitry 902 accesses and/or obtains the example state information 816 generated by the state management circuitry 708 of FIGS. 7 and/or 8. In some examples, the state information 816 indicates an example state of the device(s) 604 providing the data streams 712 to the data interface circuitry 902, where the state indicates position(s) of the device(s) 604 relative to an object, whether the device(s) 604 are idle and/or performing an operation, etc. In some examples, the data interface circuitry 902 provides the state information 816 to the mapping database 912 for storage therein. In some examples, the data interface circuitry 902 is instantiated by programmable circuitry executing data interface circuitry instructions and/or configured to perform operations such as those represented by the flowchart of FIG. 12.

The example array generation circuitry 904 of FIG. 9 generates an example array (e.g., a QoS array, a list, etc.) of possible communication metrics (e.g., possible latencies and/or bandwidths) that can be provided and/or supported by the control node 702. For example, the array generation circuitry 904 determines the possible communication metrics based on communication resources available at the control node 702, and generates the array indicating the possible communication metrics. In some examples, the array generation circuitry 904 provides the array to the example CNC node 616 of FIG. 6 at a handshake with the CNC node 616. In some examples, the array generation circuitry 904 obtains and/or receives example configuration information determined by the CNC node 616 based on the array. For example, the configuration information can include a number of the proxy data streams 812 to be preconfigured, example indices (e.g., identifiers) corresponding to the proxy data streams 812, latencies associated with one(s) of the proxy data streams 812, bandwidth allocated to the one(s) of the proxy data streams 812, etc. In some examples, the array generation circuitry 904 provides the configuration information to the mapping database 912 for storage therein. In some examples, the array generation circuitry 904 is instantiated by programmable circuitry executing array generation circuitry instructions and/or configured to perform operations such as those represented by the flowchart of FIG. 12.

The example state analysis circuitry 906 of FIG. 9 analyzes the state information 816 to determine one or more example target communication metrics (e.g., target bandwidth, target latency, etc.) corresponding to the data stream(s) 712 accessed by the stream mapping circuitry 706. In some examples, the state analysis circuitry 906 determines the target communication metric(s) based on a comparison between the state information 816 and one or more example thresholds. For example, the state analysis circuitry 906 determines that the target communication metric corresponds to a first example latency (e.g., a low latency, less than 1 millisecond, less than 2 milliseconds, etc.) when the distance between the device(s) 604 and an object on the conveyer belt 612 of FIGS. 6 and/or 7 is less than a first threshold distance. In some examples, the state analysis circuitry 906 determines that the target communication metric corresponds to a second example latency (e.g., greater than the first latency, less than 20 milliseconds, less than 30 milliseconds, etc.) when the distance between the device(s) 604 and the object is greater than or equal to the first threshold distance and less than a second threshold distance (e.g., greater than the first threshold distance). In some examples, the state analysis circuitry 906 determines that the target communication metric corresponds to a third example latency (e.g., greater than the first latency and the second latency, greater than 20 milliseconds, greater than 30 milliseconds, etc.) when the distance between the device(s) 604 and the object is greater than or equal to the second threshold distance.

In some examples, one or more different thresholds (e.g., related to positions of the device(s) 604, time of day, etc.) can be used to determine the target communication metric(s) for the data stream(s) 712. In this example, the target communication metric(s) correspond to latency. In some examples, one or more different communication metric(s) can be used instead (e.g., corresponding to bandwidth utilization, speed, etc.). In some examples, the state analysis circuitry 906 provides the target communication metric(s) to the mapping control circuitry 908 and/or to the mapping database 912 for storage therein. In some examples, the state analysis circuitry 906 is instantiated by programmable circuitry executing state analysis circuitry instructions and/or configured to perform operations such as those represented by the flowchart of FIG. 12.

The example mapping control circuitry 908 of FIG. 9 maps the data stream(s) 712 to one(s) of the proxy data streams 812 of FIG. 8 to enable sending of data to the edge node 704 of FIG. 7. For example, the mapping control circuitry 908 selects the proxy data stream(s) 812 based on the target communication metric(s) determined by the state analysis circuitry 906. In some examples, the mapping control circuitry 908 selects the first proxy data stream 812A in response to determining that the target communication metric corresponds to the first latency (e.g., less than 1 millisecond). In some examples, the mapping control circuitry 908 selects the second proxy data stream 812B in response to determining that the target communication metric corresponds to the second latency (e.g., at least 1 millisecond and less than 20 milliseconds). In some examples, the mapping control circuitry 908 selects the third proxy data stream 812C in response to determining that the target communication metric corresponds to the third latency (e.g., greater than 20 milliseconds). In some examples, the mapping control circuitry 908 maps the data stream(s) 712 to the selected one of the proxy data streams 812 to cause transmission of data from the control node 702 to the edge node 704 via the selected one of the proxy data streams 812.

In some examples, the data stream 712 is mapped to the selected one of the proxy data streams 812 for a predetermined duration and/or until new target communication metric(s) are determined by the state analysis circuitry 906. For example, the state analysis circuitry 906 can periodically reevaluate the incoming state information 816 to determine the new target communication metric(s), and the mapping control circuitry 908 can adjust the mapping based on the new target communication metric(s). In some examples, the mapping control circuitry 908 generates and/or updates example mapping information stored in the mapping database 912, where the mapping information to indicate the mapping between the data stream 712 and the selected one of the proxy data streams 812 and/or the duration associated with the mapping. In some examples, the mapping control circuitry 908 is instantiated by programmable circuitry executing mapping control circuitry instructions and/or configured to perform operations such as those represented by the flowchart of FIG. 12.

The example compression control circuitry 910 of FIG. 9 selects and/or adjusts an example compression scheme (e.g., a video compression scheme, a video compression level) for the data stream(s) 712 accessed and/or obtained by the stream mapping circuitry 706. For example, based on available bandwidth associated with the select proxy data stream(s) 812, the compression control circuitry 910 can select the compression scheme to adjust a volume of data transmitted from the data stream(s) 712 to the edge node 704. In some examples, the compression control circuitry 910 can select the compression scheme from a plurality of preset compression schemes, where the ones of the preset compression schemes are stored in association with corresponding identifiers (e.g., compression indices) stored in the mapping database 912.

In some examples, the compression control circuitry 910 selects the compression scheme based on the bandwidth available for the selected proxy data stream(s) 812 and/or based on the state information 816. For example, the compression control circuitry 910 may determine that a full resolution of video included the data stream(s) 712 is to be provided to the edge node 704 when the device(s) 406 are a first distance (e.g., less than the first threshold distance) away from the object on the conveyor belt 612. Conversely, when the device(s) 406 are at a second distance (e.g., greater than the first threshold distance) away from the object, the compression control circuitry 910 may determine that the video is to be compressed prior to sending of the video via the selected proxy data stream(s) 812. In some examples, the compression control circuitry 910 provides the compression index corresponding to the selected compression scheme to the device(s) 604 generating the data stream 712. In some examples, the compression control circuitry 910 is instantiated by programmable circuitry executing compression control circuitry instructions and/or configured to perform operations such as those represented by the flowchart of FIG. 12.

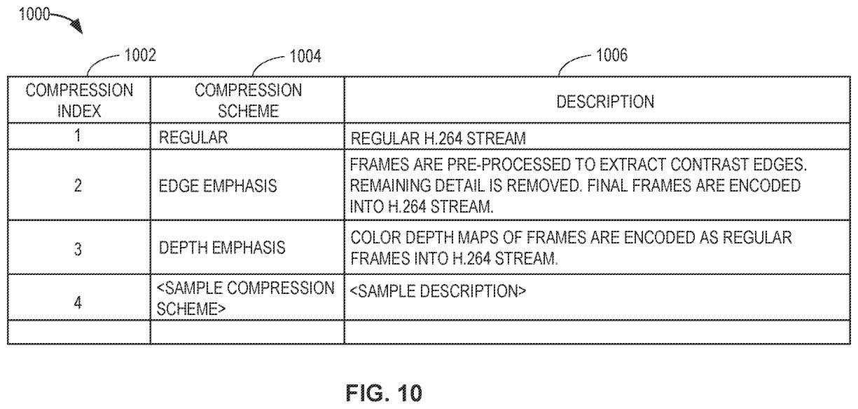

FIG. 10 is an example table 1000 representing example compression schemes (e.g., video compression schemes) that can be implemented by the stream mapping circuitry 706 of FIG. 9. In the illustrated example of FIG. 10, the table 1000 includes a second example column 1004 including the example compression schemes, a first example column 1002 including example compression indices (e.g., compression identifiers) corresponding to the compression schemes, and a third example column 1006 including example descriptions corresponding to the compression schemes. In this example, for a first example compression scheme (e.g., a regular compression scheme), video from the data stream(s) 712 is encoded into a regular H.264 stream. For a second example compression scheme (e.g., an edge emphasis compression scheme), video frames of the video are pre-processed to extract contract edges, and remaining detail is removed from the video frames prior to encoding of the video frames into the H.264 stream. For a third example compression scheme (e.g., a depth emphasis compression scheme), color depth maps of the video frames are encoded into the H.264 stream. In some examples, one or more different compression schemes can be used in addition to or instead of one(s) of the compression schemes included in the example table 1000 of FIG. 10.

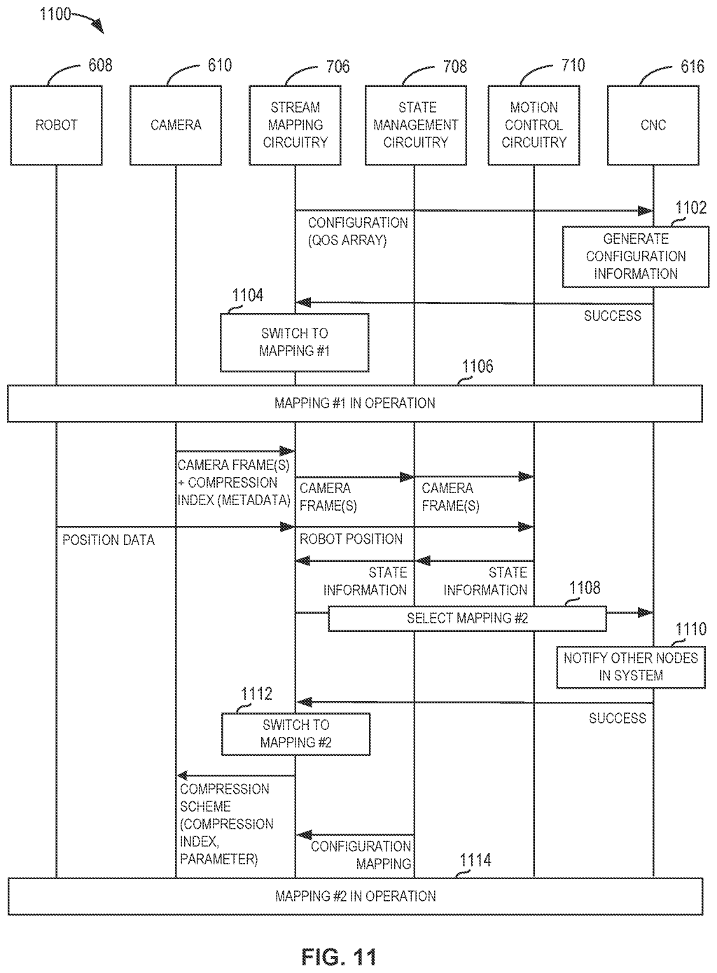

FIG. 11 illustrates an example process flow 1100 for implementing an example stream allocation procedure in accordance with teachings of this disclosure. In the illustrated example of FIG. 11, the process flow 1100 begins as the example stream mapping circuitry 706 generates and/or provides an example array (e.g., a QoS array) to the example CNC node 616. In some examples, the array includes possible QoS metrics and/or communication resources that can be supported by the example control node 702 of FIGS. 7 and/or 8. In this example, the CNC node 616 generates example configuration information (block 1102) based on the array, where the configuration information includes a number of the proxy data streams 812 to be preconfigured, example indices (e.g., identifiers) corresponding to the proxy data streams 812, latencies associated with one(s) of the proxy data streams 812, bandwidth allocated to the one(s) of the proxy data streams 812, etc. In this example, the CNC node 616 provides the configuration information to the stream mapping circuitry 706 for use in preallocating and/or preconfiguring the communication resources at the control node 702 for corresponding ones of the proxy data streams 812.

In some examples, the stream mapping circuitry 706 switches to a first example mapping (block 1104) in which the stream mapping circuitry 706 allocates the data stream(s) 712 (e.g., from the robot arm 608 and/or the camera 610) to corresponding first one(s) of the proxy data streams 812. When the first mapping is in operation (block 1106), the data stream(s) 712 are provided to the example state management circuitry 708 and/or the example motion control circuitry 710 via the first one(s) of the proxy data streams 812. For example, one of more example camera frames are provided from the camera 610 to the stream mapping circuitry 706, along with an example compression index corresponding to a first example compression scheme applied to the camera frame(s). In this example, the camera frame(s) are further provided to the state management circuitry 708 and the motion control circuitry 710 via the first one(s) of the proxy data streams 812. In this example, example position data is provided from the robot arm 608 to the stream mapping circuitry 706, and the position data is further provided to the motion control circuitry 710 via the first one(s) of the proxy data streams 812. In some examples, the state management circuitry 708 determines example state information based on the camera frame(s) provided to the state management circuitry 708 and/or based on the position data provided to the motion control circuitry 710. The state information can indicate, for example, positions and/or orientations of the robot arm 608, distance(s) between the robot arm 608 and one or more objects, whether the robot arm 608 is idle or performing one or more operations, etc.

In this example, the stream mapping circuitry 706 selects a second example mapping based on the state information (block 1108). For example, when the state information indicates that the distance between the robot arm 608 and one or more objects is less than a threshold and/or the robot arm 608 is to perform one or more operations, the stream mapping circuitry 706 determines that the data streams 712 from the robot arm 608 and/or the camera 610 are to be transmitted at a reduced latency (e.g., compared to a first latency associated with the first one(s) of the proxy data streams 812). In such examples, the stream mapping circuitry 706 selects the second mapping in which the data stream(s) 712 are mapped to second one(s) of the proxy data streams 812 corresponding to a second latency (e.g., less than the first latency). Additionally or alternatively, the stream mapping circuitry 706 selects and/or adjusts, based on the state information and/or based on a bandwidth available for the second one(s) of the proxy data streams 812, a compression scheme for compressing the camera frame(s) from the camera 610. In this example, the CNC node 616 notifies other nodes in a system (e.g., in the example TSN environment 600 of FIG. 6) of the selected second mapping (block 1110).

In the illustrated example of FIG. 11, the stream mapping circuitry 706 switches to the selected second mapping (block 1112). For example, the stream mapping circuitry 706 reallocates the data stream(s) 712 to the second one(s) of the proxy data streams 812 corresponding to the second latency, such that data from the data stream(s) 712 is provided to the state management circuitry 708 and/or the motion control circuitry 710 via the second one(s) of the proxy data streams 812. Further, in this example, the stream mapping circuitry 706 indicates the selected compression scheme to the camera 610, including a corresponding example compression index and/or one or more example parameters (e.g., the example description(s) from the third column 1006) associated with the selected compression scheme. In this example, the second mapping remains in operation (block 1114) for a preset duration and/or until the stream mapping circuitry 706 obtains new state information indicating a change in the target latency for the data stream(s) 712.

FIG. 12 is a flowchart representative of example machine readable instructions and/or example operations 1200 that may be executed, instantiated, and/or performed by programmable circuitry to implement the example stream mapping circuitry 706 of FIG. 9. The example machine-readable instructions and/or the example operations 1200 of FIG. 12 begin at block 1202, at which the example stream mapping circuitry 706 identifies example communication metrics (e.g., QoS parameters) available to the example control node 702 of FIGS. 7 and/or 8. For example, the example array generation circuitry 904 of FIG. 9 identifies available communication resources available to the control node 702 to determine the communication metrics (e.g., latencies, bandwidths, speed, etc.) that can be provided and/or supported by the control node 702. In some examples, the array generation circuitry 904 generates an example array (e.g., a list, a report) of the available communication metrics, and provides the array to the example CNC node 616 of FIG. 6.

At block 1204, the example stream mapping circuitry 706 determines and/or identifies a plurality of example proxy data streams 812 based on the available communication metrics. For example, the array generation circuitry 904 determines the proxy data streams 812 based on example configuration information generated by the CNC node 616 based on the array of available communication metrics. For example, the array generation circuitry 904 accesses and/or receives the configuration information from the CNC node 616, where the configuration information indicates a number of the proxy data streams 812 to be preconfigured, example indices (e.g., identifiers) corresponding to the proxy data streams 812, latencies associated with one(s) of the proxy data streams 812, bandwidth allocated to the one(s) of the proxy data streams 812, etc.

At block 1206, the example stream mapping circuitry 706 selects a first example mapping (e.g., a first configuration) of one or more data streams 712 to one(s) of the proxy data streams 812. For example, the example mapping control circuitry 908 of FIG. 9 selects the first mapping in which the data stream(s) 712 are to be mapped (e.g., allocated, assigned) to first one(s) of the proxy data streams 812. In some examples, the first mapping corresponds to a default mapping stored in the example mapping database 912 of FIG. 9.

At block 1208, the example stream mapping circuitry 706 obtains the data stream(s) 712 provided to a first example edge device (e.g., the example control node 702 of FIGS. 7 and/or 8) from one or more of the example devices 604 of FIGS. 6 and/or 7. For example, the example data interface circuitry 902 obtains, accesses, and/or receives the data stream(s) 712 from one or more of the robot arm(s) 608 and/or the camera(s) 610 of FIGS. 6 and/or 7. In some examples, the data stream(s) 712 include image data stream(s) from the camera(s) 610 and/or position data stream(s) from the robot arm(s) 608.

At block 1210, the example stream mapping circuitry 706 causes transmission of the data stream(s) 712 to a second example edge device (e.g., the edge node 704 of FIGS. 7 and/or 8) based on the selected mapping. For example, the mapping control circuitry 908 causes data from the data stream(s) 712 to be transmitted to the edge node 704 via the first one(s) of the proxy data streams 812. In this example, the first one(s) of the proxy data correspond to one or more first communication metrics (e.g., a first latency, a first bandwidth, a first speed, etc.).

At block 1212, the example stream mapping circuitry 706 obtains and/or accesses example state information 816 based on the data stream(s) 712. For example, the example state analysis circuitry 906 accesses the state information 816 generated by the example state management circuitry 708 implemented at the edge node 704. In some examples, the state information 816 represents positions and/or orientations of the device(s) 604 associated with the data stream(s) 712, distance(s) between the device(s) 604 and one or more objects, whether the device(s) 604 are idle and/or performing one or more operations, etc.

At block 1214, the example stream mapping circuitry 706 selects a target communication metric based on the state information 816. For example, the state analysis circuitry 906 selects a target latency, a target bandwidth, a target speed, etc. for the data stream(s) 712 based on the state information 816. In some examples, the state analysis circuitry 906 determines the target communication metric by evaluating the state information 816 based on one or more example thresholds. For example, the state analysis circuitry 906 selects a first target communication metric when the distance between the device(s) 604 and an object satisfies (e.g., is less than) an example distance threshold, and the state analysis circuitry 906 selects a second target communication metric (e.g., different from the first target communication metric) when the distance does not satisfy (e.g., is greater than or equal to) the distance threshold. In some examples, one or more different thresholds (e.g., related to the position(s) of the device(s) 604, related to time of day, etc.) can be used instead.

At block 1216, the example stream mapping circuitry 706 determines whether to switch the selected mapping. For example, the mapping control circuitry 908 determines that a new mapping is to be selected when the target communication metric is different from (e.g., by a threshold amount) a communication metric associated with the selected mapping. In response to the mapping control circuitry 908 determining not to switch the mapping (e.g., block 1216 returns a result of NO), control returns to block 1208. Alternatively, in response to the mapping control circuitry 908 determining that a new mapping is to be selected (e.g., block 1216 returns a result of YES), control proceeds to block 1218.

At block 1218, the example stream mapping circuitry 706 selects, based on the target communication metric, a second example mapping for the data stream(s) 712 to the proxy data streams 812. For example, the mapping control circuitry 908 selects the second example mapping in which the data stream(s) 712 are mapped to second one(s) of the proxy data streams 812 satisfying the target communication metric. In some examples, the mapping control circuitry 908 causes the data stream(s) 712 to be transmitted to the edge node 704 via the second one(s) of the proxy data streams 812.

At block 1220, the example stream mapping circuitry 706 selects an example compression scheme (e.g., a compression level) for the data stream(s) 712. For example, the compression control circuitry 910 selects the compression scheme based on the bandwidth available for the selected proxy data stream(s) 812 and/or based on the state information 816.

At block 1222, the example stream mapping circuitry 706 determines whether to continue monitoring. For example, the data interface circuitry 902 determines to continue monitoring while data is being streamed to the control node 702. In some examples, in response to the data interface circuitry 902 determining to continue monitoring (e.g., block 1222 returns a result of YES), control returns to block 1208. Alternatively, in response to the data interface circuitry 902 determining not to continue monitoring (e.g., block 1222 returns a result of NO), control ends.

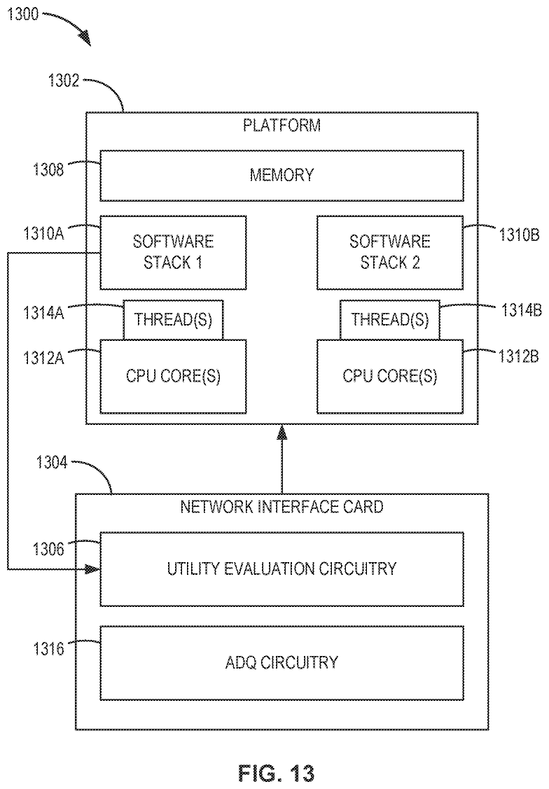

FIG. 13 illustrates an example system 1300 for managing data ingestion, where the system 1300 includes an example platform (e.g., a server platform, a computing platform, a processor platform) 1302 and an example network interface card (NIC) 1304 implementing example utility evaluation circuitry 1306 in accordance with teachings of this disclosure. In some examples, the platform 1302 is implemented at one or more example devices (e.g., edge devices, compute devices, etc.) in an example network (e.g., a network environment), and the platform 1302 is configured to obtain, access, and/or receive data (e.g., data packets, network packets) sent via the network. In this example, the platform 1302 includes example memory 1308, example software stacks 1310, example cores (e.g., CPU cores) 1312, and one or more example threads 1314 executed by corresponding one(s) of the cores 1312. In this example, the NIC 1304 implements example Application Device Queue (ADQ) circuitry 1316. While the utility evaluation circuitry 1316 and the ADQ circuitry 1316 are implemented by the NIC 1304 in this example, the utility evaluation circuitry 1316 and/or the ADQ circuitry 1316 can be implemented by other network processing hardware (e.g., an infrastructure processing unit (IPU), an Ethernet controller (EC), a data processing unit (DPU), a smart NIC, an edge processing unit (EPU), a system-on-a-chip (SOC), a multi-chip module, LAN on motherboard (LOM), etc.). Further, while ADQ circuitry is used in this examples, one or more different queue-based types of network technologies may additionally or alternatively be used.

In the illustrated example of FIG. 13, the platform 1302 stores and/or processes data received at the platform 1302 via the NIC 1304. In this example, the software stacks 1310 correspond to software components that enable respective different applications to run on the platform 1302. For example, the software components can include one or more databases, one or more programming languages, one or more operating systems, etc. In some examples, the first software stack 1310A can correspond to a first application (e.g., an image processing application), and the second software stack 1310B can correspond to a second application (e.g., a sensor data processing application) different from the first application. In some examples, the software stacks 1310 can pass data to corresponding one(s) of the threads 1314 to be executed by corresponding one(s) of the cores 1312. In this example, the platform 1302 includes two of the software stacks 1310. In some examples, a different number of the software stacks 1310 can be used instead.

In the illustrated example of FIG. 13, the NIC 1304 accesses, obtains, and/or receives data sent via the network. In some examples, the NIC 1304 forwards the data to the platform 1302 for processing and/or storage. For example, data to be processed by the core(s) 1312 and/or processed data output by the core(s) 1312 can be stored (e.g., temporarily and/or permanently) in the memory 1308. In some examples, the NIC 1304 receives data from a large number (e.g., thousands, tens of thousands, etc.) of devices at a given time, and an amount of the data received at the NIC 1304 may exceed a threshold amount of data that can be stored in the memory 1308 of the platform 1302. As such, in the illustrated example of FIG. 13, the utility evaluation circuitry 1306 is implemented at the NIC 1304 to identify data that can be dropped (e.g., instead of forwarded to the platform 1302). In some examples, the utility evaluation circuitry 1306 reduces the amount of data to be forwarded to and/or ingested by the platform 1302, thus reducing utilization of memory and/or computational resources at the platform 1302.

In this example, the utility evaluation circuitry 1306 evaluates whether one or more data packets received at the NIC 1304 are to be dropped or forwarded to the platform 1302 based on execution of one or more utility functions (e.g., processing functions, entropy functions, etc.) registered with the utility evaluation circuitry 1306. For example, the utility evaluation circuitry 1306 executes the utility function(s) based on a payload of the data packet(s) received at the NIC 1304 and/or based on historic information associated with data ingested at the platform. As a result of the execution, the utility evaluation circuitry 1306 determines an example utility value (e.g., an entropy value, an entropy score) associated with the received data packet(s). In some examples, the utility value represents an amount of new and/or useful (e.g., non-redundant) information included in the data packet(s). In some examples, the utility evaluation circuitry 1306 forwards first one(s) of the data packets to the platform 1302 when the corresponding utility value(s) satisfy one or more thresholds, and the utility evaluation circuitry 1306 drops (e.g., does not forward) second one(s) of the data packets when the corresponding utility value(s) do not satisfy the one or more thresholds. In some examples, the utility evaluation circuitry 1316 can also map the utility function(s) to corresponding queues (e.g., ADQs) implemented by the ADQ circuitry 1316.

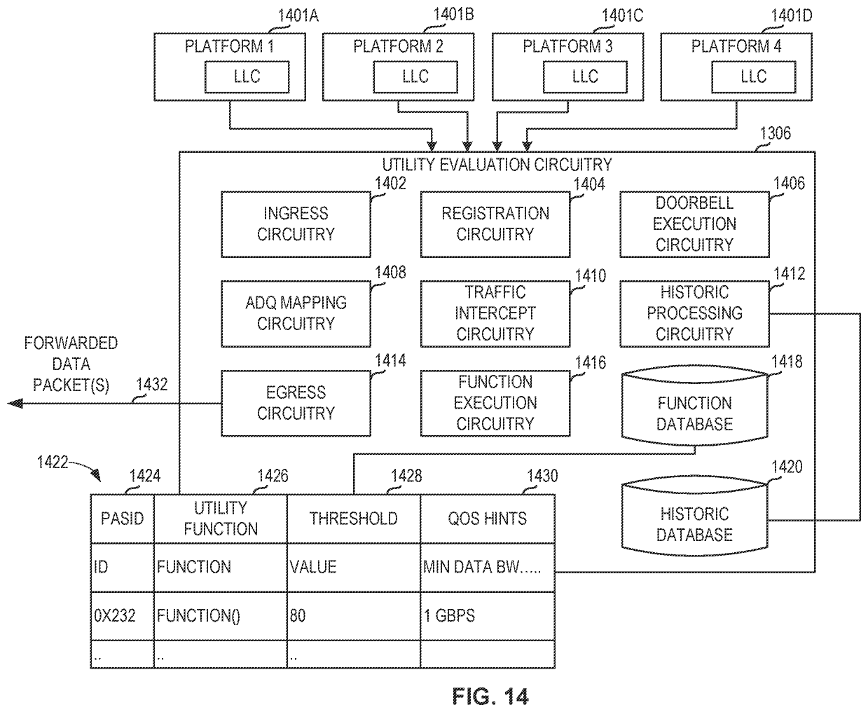

FIG. 14 is a block diagram of an example implementation of the example utility evaluation circuitry 1306 of FIG. 13. The utility evaluation circuitry 1306 of FIG. 14 may be instantiated (e.g., creating an instance of, bring into being for any length of time, materialize, implement, etc.) by programmable circuitry such as a Central Processor Unit (CPU) executing first instructions. Additionally or alternatively, the utility evaluation circuitry 1306 of FIG. 14 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 14 may, thus, be instantiated at the same or different times. Some or all of the circuitry of FIG. 14 may be instantiated, for example, in one or more threads executing concurrently on hardware and/or in series on hardware. Moreover, in some examples, some or all of the circuitry of FIG. 14 may be implemented by microprocessor circuitry executing instructions and/or FPGA circuitry performing operations to implement one or more virtual machines and/or containers.

In the illustrated example of FIG. 14, the utility evaluation circuitry 1306 includes example ingress circuitry 1402, example registration circuitry 1404, example doorbell execution circuitry 1406, example ADQ mapping circuitry 1408, example traffic intercept circuitry 1410, example historic processing circuitry 1412, example egress circuitry 1414, example function execution circuitry 1416, an example function database 1418, and an example historic database 1420.

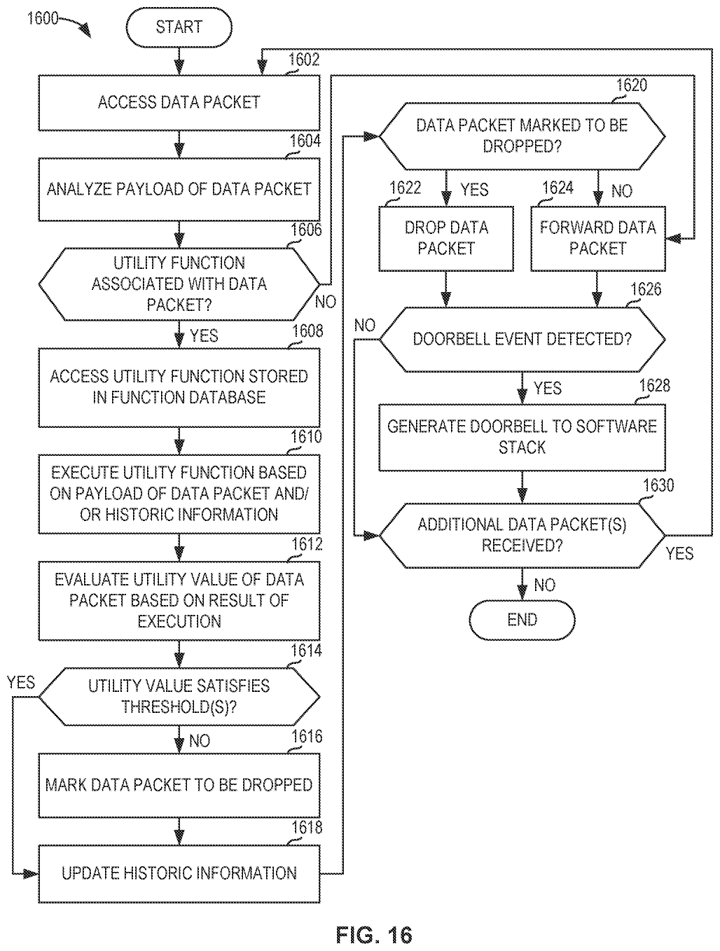

The example ingress circuitry 1402 of FIG. 14 obtains, accesses, and/or receives data from one or more example platforms 1401. For example, one(s) of the platforms 1401 shown in FIG. 14 can be associated with respective different devices (e.g., temperature sensor(s), carbon monoxide sensor(s), camera(s), etc.) in a network, and the ingress circuitry 1402 obtains the data (e.g., temperature data, image data, other sensor data, etc.) output by one(s) of the devices. In some examples, the data can be provided to the ingress circuitry 1402 as one or more data packets (e.g., network packet(s)). Additionally or alternatively, the data can be provided to the ingress circuitry 1402 as one or more data streams. In some examples, the ingress circuitry 1402 is instantiated by programmable circuitry executing ingress circuitry instructions and/or configured to perform operations such as those represented by the flowchart(s) of FIG. 16.

The example registration circuitry 1404 of FIG. 14 enables one(s) of the software stacks 1310 of FIG. 13 to register one or more new utility functions with the NIC 1304. For example, the registration circuitry 1404 can register the new utility function(s) in response to a request from the one(s) of the software stacks 1310. In some examples, the request includes registration information associated with the software stack(s) 1310 and/or the utility function(s) to be registered. For example, the registration information can include a process address identifier (PASID) corresponding to the software stack(s) 1310, a queue identifier corresponding to one(s) of the ADQs to which the utility function and/or the PASID is mapped, the utility function (and/or a location of the utility function) to be registered, a function identifier (e.g., a universally unique identifier) corresponding to the utility function, and/or a threshold (e.g., a utility threshold) associated with the utility function. In some examples, the function identifier is generated by the registration circuitry 1404 and/or provided to the registration circuitry 1404 from the software stack(s) 1310.

In some examples, the utility function includes at least one of a pseudo algorithm, a binary function, or an accelerated function (e.g., a function implemented in FPGA logic). In some examples, the utility function includes a data shaping function. For example, the utility function can include one or more filters and/or implement one or more sampling techniques (e.g., simple random probability sampling, stratified random probability sampling, etc.) that are applied to data received at the ingress circuitry 1402. In some examples, the utility function, when executed, outputs an example utility value (e.g., a utility score, an entropy score) associated with a payload of a data packet, where the utility value can be used to determine whether the data packet is to be dropped or forwarded to the platform 1302 of FIG. 13. Additionally or alternatively, as a result of the execution, the utility function can output characterization data associated with the data packet, where the characterization data can indicate data types included and/or not included in the data packet.

In some examples, the registration circuitry 1404 generates and/or updates, based on the registration information, an example registration table (e.g., a function registration table) 1422 stored in the example function database 1418 of FIG. 14. The example function database 1418 is implemented by any memory, storage device and/or storage disc for storing data such as, for example, flash memory, magnetic media, optical media, solid state memory, hard drive(s), thumb drive(s), etc. Furthermore, the data stored in the example function database 1418 may be in any data format such as, for example, binary data, comma delimited data, tab delimited data, structured query language (SQL) structures, etc. While, in the illustrated example, the example function database 1418 is illustrated as a single device, the example function database 1418 and/or any other data storage devices described herein may be implemented by any number and/or type(s) of memories.

In the illustrated example of FIG. 14, the registration table 1422 includes information corresponding to one(s) of the utility functions registered with the utility evaluation circuitry 1306. For example, example rows (e.g., entries) of the registration table 1422 correspond to respective different one(s) of the registered utility functions. In particular, the registration table 1422 includes a second example column 1426 representing the registered utility functions (e.g., including locations and/or function identifiers corresponding to the registered utility functions). The first example column 1424 of the registration table 1422 includes the example PASIDs corresponding to the software stack(s) 1310 to which the respective utility functions are mapped, and the third example column 1428 of the registration table 1422 includes example thresholds corresponding to the utility functions. In this example, the registration table 1422 includes a fourth example column 1430 including example quality of service (QoS) parameters associated with the corresponding utility functions in the second column 1426. In some examples, the QoS parameters correspond to data rates (e.g., minimum and/or maximum data rates), latency rates, priority rates, etc. for one(s) of the utility functions. While the registration table 1422 includes four of the columns 1424, 1426, 1428, 1430 in the example of FIG. 14, the registration table 1422 can include one or more different columns (e.g., corresponding to the queue identifier(s), etc.) instead.

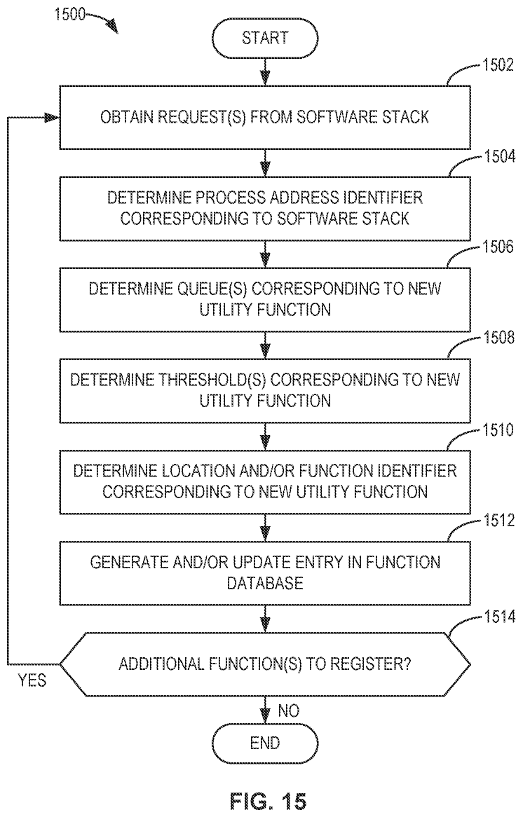

In some examples, the registration circuitry 1404 can add, delete, and/or modify one or more entries of the registration table 1422. For example, the registration circuitry 1404 can add one or more entries in response to receiving a request from one(s) of the software stacks 1310 to register one or more new utility functions. In some examples, the registration circuitry 1404 can modify and/or reset one or more of the function identifiers, the utility functions, the thresholds, and/or the QoS parameters included in the registration table 1422. In some examples, the registration table 422 can be modified based on request(s) from the platform 1302 of FIG. 13 and/or based on user input(s). In some examples, the registration circuitry 1404 is instantiated by programmable circuitry executing registration circuitry instructions and/or configured to perform operations such as those represented by the flowchart(s) of FIG. 15.

The example traffic intercept circuitry 1410 intercepts network traffic from one(s) of the platforms 1401 of FIG. 14 to the NIC 1304 of FIG. 13. For example, the traffic intercept circuitry 1410 performs in-line processing of data packets received by the NIC 1304, and the traffic intercept circuitry 1410 provides one(s) of the data packets to the function execution circuitry 1416 of FIG. 14 for further processing and/or analysis. In some examples, the traffic intercept circuitry 1410 intercepts one(s) of the data packets for which there is a corresponding utility function stored in the function database 1418. In some examples, the traffic intercept circuitry 1410 intercepts a portion (e.g., all) of the data packets received at the NIC 1304. In some examples, the traffic intercept circuitry 1410 selects the portion of the data packets to be intercepted based on a time of day, based on a source of the data packets, etc. In some examples, the traffic intercept circuitry 1410 intercepts one(s) of the data packets periodically (e.g., at a preset frequency) and/or after a threshold number of data packets have been received at the NIC 1304. In some examples, the traffic intercept circuitry 1410 intercepts one(s) of the data packets based on one or more sampling techniques implemented for one(s) of the platforms 1401. In some examples, the traffic intercept circuitry 1410 is instantiated by programmable circuitry executing traffic intercept circuitry instructions and/or configured to perform operations such as those represented by the flowchart(s) of FIG. 16.

The example function execution circuitry 1416 of FIG. 14 selects and/or identifies one or more utility functions to determine whether to drop or forward an intercepted data packet from an example data stream. For example, the function execution circuitry 1416 accesses a payload of the data packet and identifies, based on the payload, one(s) of the utility functions associated with the data packet. For example, the payload can include at least one of a PASID corresponding to one of the software stack(s) 1310, a function identifier corresponding to the one(s) of the utility functions, a queue identifier associated with one of the ADQs to which the data packet is mapped, etc. In some examples, the function execution circuitry 1416 accesses and/or obtains the identified one(s) of the utility function from the function database 1418.

In some examples, the function execution circuitry 1416 accesses and/or obtains historic information corresponding to the data packet and/or the associated data stream. For example, the function execution circuitry 1416 accesses and/or obtains the historic information stored in the historic database 1420 of FIG. 14. The example historic database 1420 is implemented by any memory, storage device and/or storage disc for storing data such as, for example, flash memory, magnetic media, optical media, solid state memory, hard drive(s), thumb drive(s), etc. Furthermore, the data stored in the example historic database 1420 may be in any data format such as, for example, binary data, comma delimited data, tab delimited data, structured query language (SQL) structures, etc. While, in the illustrated example, the example historic database 1420 is illustrated as a single device, the example historic database 1420 and/or any other data storage devices described herein may be implemented by any number and/or type(s) of memories.

In some examples, the historic information includes results from prior execution of the one(s) of the utility functions. For example, the historic information can include example characteristic(s) associated with one or more prior data packets previously evaluated by the function execution circuitry 1416 based on the one(s) of the utility functions, and/or can include indications of whether the prior data packets were dropped or forwarded. In some examples, the characteristic(s) can include first data types included in payloads of the prior data packets, second data types not included in the payloads of the prior data packets, data values (e.g., for corresponding one(s) of the data types) included in the payloads of the prior data packets, etc.

In the illustrated example of FIG. 14, to determine whether to forward or drop an intercepted data packet, the function execution circuitry 1416 executes the selected utility function(s) based on a payload of the data packet and/or based on the historic information associated with one or more data stream(s) received at the NIC 1304. For example, the function execution circuitry 1416 provides the payload of the data packet and/or the historic information as input(s) to the utility function(s) and, as a result of the execution, the utility function(s) output example utility value(s) corresponding to the data packet, example characterization data corresponding to the data packet, and/or an indication of whether the data packet is to be forwarded or dropped. In some examples, the function execution circuitry 1416 determines whether to forward or drop the data packet based on the indication output by the utility function(s). Additionally or alternatively, the function execution circuitry 1416 determines whether to forward or drop the data packet based on a comparison of the utility value(s) to one or more example utility thresholds.

In some examples, the utility value(s) are based on an amount of variability and/or difference(s) between the payload of the data packet and the historic information from the data stream associated with the data packet. For example, when the data stream is from a sensor (e.g., a temperature sensor, a carbon monoxide sensor, a video camera, etc.) operating in an environment, data from the data stream has relatively low utility (e.g., has low entropy, includes redundant information, etc.) when the data is relatively unchanging (e.g., where there are little or no variations in the data over time). Conversely, the data from the data stream can have relatively high utility (e.g., high entropy) when the data is anomalous and/or when the data varies significantly (e.g., more than a threshold) over time. In some examples, the utility value for the data packet corresponds to the difference between the payload of the current data packet and the payload(s) of one or more prior data packets associated with the data stream.

Additionally or alternatively, the utility value(s) are based on an amount of variability and/or difference(s) between the data stream associated with the current data packet and one or more additional data streams received at the NIC 1304. For example, the data streams can be from respective different sensors (e.g., temperature sensors, carbon monoxide sensors, video cameras, etc.) positioned at different locations in a physical environment, and one(s) of the sensors can collect data corresponding to respective regions (e.g., geographic regions) of the physical environment. In some such examples, when ones of the geographic regions overlap, corresponding ones of the data streams can include redundant and/or repeating information. In some such examples, the utility value for the current data stream corresponds to an amount of non-repeating and/or unique information represented in the data packet (e.g., and not included the other one(s) of the data streams).

In some examples, when the utility value of the current data packet does not satisfy (e.g., is less than) the utility threshold(s), the function execution circuitry 1416 determines that the current data packet does not include a threshold amount of new and/or useful information and, thus, determines that the current data packet is to be dropped. Conversely, when the utility value of the current data packet satisfies (e.g., is greater than) the utility threshold(s), the function execution circuitry 1416 determines that the current data packet includes a threshold amount of new and/or useful information and, thus, determines that the current data packet is to be forwarded to the software stack(s) 1310 of FIG. 13.

In some examples the function execution circuitry 1416 can determine whether to drop or forward the data packet based on one or more preset and/or user-defined rules for respective one(s) of the data streams. For example, as a result of execution of the utility function(s), the function execution circuitry 1416 can filter data from the data stream based on one or more example characteristics (e.g., based on time of day, temperature, carbon monoxide level, data pattern type, etc.) as defined by the example rule(s). In some examples, the function execution circuitry 1416 identifies the filtered data (e.g., one(s) of the data packets that satisfy the rule(s)) to be forwarded to the software stack(s) 1310 of FIG. 13. In some examples, in response to determining that one(s) of the data packets are to be dropped, the function execution circuitry 1416 marks the one(s) of the data packets to be dropped. For example, the function execution circuitry 1416 can mark the one(s) of the data packets by including an indication in the data packet(s) (e.g., in the payload(s) of the data packet(s)) to indicate that the data packet(s) are to be dropped. In some examples, the function execution circuitry 1416 is instantiated by programmable circuitry executing function execution circuitry instructions and/or configured to perform operations such as those represented by the flowchart(s) of FIG. 16.

In the illustrated example of FIG. 14, the historic processing circuitry 1412 accesses and/or updates the historic information stored in the historic database 1420 of FIG. 14. For example, the historic processing circuitry 1412 can store characterization data for the data packet(s) (e.g., data types included and/or not included in the payload(s) of the data packet(s), utility value(s) of the data packet(s), etc.) in association with corresponding indication(s) of whether the data packet(s) were forwarded or dropped. In some examples, the historic processing circuitry 1412 can store the characterization data and/or the indication(s) in association with the corresponding function identifier(s) of utility function(s) executed for the data packet(s). In some examples, the historic processing circuitry 1412 can update the historic information to indicate a first number and/or a first percentage of the data packets that have been dropped, a second number and/or a second percentage of the data packets that have been forwarded, a rate at which the data packets have been dropped (e.g., a number of the data packets dropped per duration), sampling rate(s) corresponding to the data stream(s), etc.

In some examples, the historic processing circuitry 1412 generates and/or updates statistical information (e.g., statistical models, graphs, traces, etc.) based on the historic information. For example, the historic processing circuitry 1412 can generate and/or update one or more example histograms for the corresponding utility function(s), where the histograms can indicate, for example, a number of data packets per data type that were dropped (or forwarded) based on the utility function(s) in a given duration. In some examples, one or more different histograms and/or other graphs can be used instead. In some examples, the historic processing circuitry 1412 can delete and/or modify the historic data based on available memory in the historic database and/or based on a duration of interest. For example, the historic processing circuitry 1412 can retain the historic information corresponding to the duration of interest (e.g., the prior N units of time), and the historic processing circuitry 1412 deletes the historic information not corresponding to the duration of interest. In some examples, the historic processing circuitry 1412 deletes a portion of the historic information when the available memory at the historic database is less than a threshold. In some examples, the historic processing circuitry 1412 is instantiated by programmable circuitry executing historic processing circuitry instructions and/or configured to perform operations such as those represented by the flowchart(s) of FIG. 16.

The example doorbell execution circuitry 1406 of FIG. 14 generates and/or provides an example alert (e.g., a doorbell) to the software stack(s) 1310 in response to detection of an event. For example, the event can include the function execution circuitry 1416 marking at least threshold number and/or percentage of the data packet(s) to be dropped (or forwarded), the historic processing circuitry 1412 updating the historic information at least a threshold number of times, an amount of memory used to store the historic information for one(s) of the utility functions being at or above a threshold amount, etc. In some examples, the event and/or the threshold(s) associated therewith can be preset and/or can be defined and/or modified by a user. In some examples, in response to detecting an event associated with one(s) of the utility function, the doorbell execution circuitry 1406 generates and/or provides the alert(s) to one(s) of the software stacks 1310 corresponding to the one(s) of the utility functions. In some examples, the alert(s) can include historic and/or statistical information associated with the one(s) of the utility functions. In some examples, the doorbell execution circuitry 1406 is instantiated by programmable circuitry executing doorbell execution circuitry instructions and/or configured to perform operations such as those represented by the flowchart(s) of FIG. 16.

The example ADQ mapping circuitry 1408 maps one(s) of the data packets and/or the associated utility functions to corresponding one(s) of the ADQs provided by the ADQ circuitry 1316 of FIG. 13. For example, the ADQ mapping circuitry 1408 determines the mapping based on the queue identifiers stored in association with one(s) of the utility functions in the function database 1418. In some examples, the ADQ mapping circuitry 1408 is instantiated by programmable circuitry executing ADQ mapping circuitry instructions and/or configured to perform operations such as those represented by the flowchart(s) of FIG. 16.

The example egress circuitry 1414 of FIG. 14 provides example forwarded data packets 1432 to the example platform 1302 of FIG. 13. For example, the egress circuitry 1414 identifies the forwarded data packets 1432 corresponding to first one(s) of the data packets that have not been marked to be dropped (and/or have been marked to be forwarded) by the function execution circuitry 1416. In some examples, the egress circuitry 1414 provides the forwarded data packets 1432 to corresponding one(s) of the software stacks 1310, where the one(s) of the software stacks 1310 can be identified based on the PASIDs stored in payload(s) of the data packets and/or based on the registration table 1422. In some examples, the egress circuitry 1414 can store historic information and/or statistical information in one(s) of the forwarded data packets 1432 to be forwarded to the software stacks 1310. In this example, the egress circuitry 1414 drops (e.g., deletes, does not forward) second one(s) of the data packets that have been marked to be dropped by the function execution circuitry 1416. In some examples, the egress circuitry 1414 is instantiated by programmable circuitry executing egress circuitry instructions and/or configured to perform operations such as those represented by the flowchart(s) of FIG. 16.

FIG. 15 is a flowchart representative of example machine readable instructions and/or example operations 1500 that may be executed, instantiated, and/or performed by programmable circuitry to implement the utility evaluation circuitry 1306 of FIGS. 13 and/or 14 to register a new utility function. The example machine-readable instructions and/or the example operations 1500 of FIG. 15 begin at block 1502, at which the example utility evaluation circuitry 1306 obtains one or more example requests from one of the software stacks 1310 of FIG. 13. For example, the example registration circuitry 1404 obtains and/or accesses the request(s) from the software stack 1310, where the request(s) include registration information associated with the software stack 1310 and/or the new utility function to be registered.

At block 1504, the example utility evaluation circuitry 1306 determines an example identifier (e.g., a PASID) corresponding to the software stack 1310. For example, the registration circuitry 1404 determines and/or obtains the PASID from the registration information included in the request(s).

At block 1506, the example utility evaluation circuitry 1306 determines one or more example queues corresponding to the new utility function to be registered. For example, the registration circuitry 1404 determines and/or identifies the queue (e.g., ADQ) from the registration information included in the request(s), and/or identifies the queue based on the PASID.

At block 1508, the example utility evaluation circuitry 1306 determines one or more example thresholds (e.g., utility threshold(s)) corresponding to the new utility function to be registered. For example, the registration circuitry 1404 determines and/or identifies the threshold(s) from the registration information included in the request(s). In some examples, the threshold(s) indicate threshold utility values at which one or more data packets are to be forwarded or dropped. In some examples, the threshold(s) are preset and/or user-defined, and the threshold(s) can be modified based on additional request(s) from the software stack 1310.

At block 1510, the example utility evaluation circuitry 1306 determines a location (e.g., a location in the example function database 1418 of FIG. 14) and/or a function identifier corresponding to the new utility function to be registered. For example, the registration circuitry 1404 determines and/or identifies the location and/or the function identifier from the registration information included in the request(s).

At block 1512, the example utility evaluation circuitry 1306 generates and/or updates one or more example entries in the example function database 1418 of FIG. 14. For example, the registration circuitry 1404 generates and/or updates an entry of the example registration table 1422 of FIG. 14 to include the new utility function, the PASID corresponding to the software stack 1310, the function identifier and/or the location corresponding to the new utility function, the queue(s) corresponding to the new utility function, and/or the threshold(s) corresponding to the new utility function.

At block 1514, the example utility evaluation circuitry 1306 determines whether there are one or more additional requests to register in the function database 1418. For example, the registration circuitry 1404 determines there are additional function(s) to register in response to obtaining and/or receiving one or more additional requests from one(s) of the software stacks 1310. In response to the registration circuitry 1404 determining that there are additional function(s) to register (e.g., block 1514 returns a result of YES), control returns to block 1502. Alternatively, in response to the registration circuitry 1404 determining that there are no additional function(s) to register (e.g., block 1514 returns a result of NO), control ends.

FIG. 16 is a flowchart representative of example machine readable instructions and/or example operations 1600 that may be executed, instantiated, and/or performed by programmable circuitry to implement the utility evaluation circuitry 1306 of FIGS. 13 and/or 14 to drop and/or forward example data packet(s). The example machine-readable instructions and/or the example operations 1600 of FIG. 16 begin at block 1602, at which the example utility evaluation circuitry 1306 accesses an example data packet. For example, the example ingress circuitry 1402 of FIG. 14 accesses the data packet provided by one of the example platforms 1401 of FIG. 14. In some examples, the data packet can be associated with an example data stream output by one or more sensors (e.g., temperature sensor(s), carbon monoxide sensor(s), camera(s), etc.) associated with the platform 1401.

At block 1604, the example utility evaluation circuitry 1306 analyzes an example payload of the data packet. For example, the example traffic intercept circuitry 1410 of FIG. 14 analyzes the payload to determine whether the data packet includes at least one identifier (e.g., a function identifier, a PASID, a queue identifier, etc.) corresponding to one of the utility functions stored in the example function database 1418 of FIG. 14.

At block 1606, the example utility evaluation circuitry 1306 determines whether there is a utility function associated with the data packet. For example, the traffic intercept circuitry 1410 determines that there is a utility function associated with the data packet when the payload includes the at least one identifier corresponding to one of the utility functions. In response to the traffic intercept circuitry 1410 determining that a utility function is associated with the data packet (e.g., block 1606 returns a result of YES), control proceeds to block 1608. Alternatively, in response to the traffic intercept circuitry 1410 determining that there is no utility function associated with the data packet (e.g., block 1606 returns a result of NO), control proceeds to block 1624.

At block 1608, the example utility evaluation circuitry 1306 accesses an example utility function stored in the function database 1418. For example, the example function execution circuitry 1416 of FIG. 14 evaluates one or more entries of the example registration table 1422 based on the at least identifier (e.g., the function identifier, the PASID, the queue identifier, etc.) identified in the payload of the data packet. In some examples, the function execution circuitry 1416 accesses the utility function from one of the entries corresponding to the at least one identifier.

At block 1610, the example utility evaluation circuitry 1306 executes the utility function based on the payload of the data packet and/or based on historic information associated with the utility function. For example, the function execution circuitry 1416 provides the payload of the data packet and/or the historic information as input(s) to the utility function(s) and, as a result of the execution, the utility function(s) output example utility value(s) corresponding to the data packet, example characterization data corresponding to the data packet, and/or an indication of whether the data packet is to be forwarded or dropped.

At block 1612, the example utility evaluation circuitry 1306 evaluates the utility value of the data packet based on a result of the execution. For example, the function execution circuitry 1416 determines whether to forward or drop the data packet based on a comparison of the utility value(s) to one or more example utility thresholds. In some examples, the utility value(s) are based on difference(s) between the payload of the data packet and the historic information from the data stream associated with the data packet. In some examples, the utility value(s) are based on difference(s) between the data stream associated with the data packet and one or more additional data streams.

At block 1614, the example utility evaluation circuitry 1306 determines whether the utility value satisfies one or more example thresholds (e.g., utility thresholds). In response to the function execution circuitry 1416 determining that the utility value satisfies the threshold(s) (e.g., block 1614 returns a result of YES), control proceeds to block 1618. Alternatively, in response to the function execution circuitry 1416 determining that the utility value does not satisfy the threshold(s) (e.g., block 1614 returns a result of NO), control proceeds to block 1616.

At block 1616, the example utility evaluation circuitry 1306 marks the data packet to be dropped. For example, the function execution circuitry 1416 can mark the data packet to be dropped by including an indication in the data packet (e.g., in the payload of the data packet).

At block 1618, the example utility evaluation circuitry 1306 updates the historic information stored in the example historic database 1420 of FIG. 14. For example, the example historic processing circuitry 1412 of FIG. 14 generates and/or updates the historic information to include the characterization data corresponding to the data packet, an indication of whether the data packet is to be dropped or forwarded, a number and/or a percentage of the data packets that have been dropped (or forwarded), etc.

At block 1620, the example utility evaluation circuitry 1306 determines whether the data packet is marked to be dropped. For example, the example egress circuitry 1414 determines that the data packet is marked to be dropped when the payload of the data packet includes an indication that the data packet is to be dropped. In response to the egress circuitry 1414 determining that the data packet is to be dropped (e.g., block 1620 returns a result of YES), control proceeds to block 1622. Alternatively, in response to the egress circuitry 1414 determining that the data packet is not to be dropped and/or is to be forwarded (e.g., block 1620 returns a result of NO), control proceeds to block 1624.

At block 1622, the example utility evaluation circuitry 1306 drops the data packet. For example, the egress circuitry 1414 drops and/or deletes the data packet and/or otherwise does not deliver the data packet to the corresponding software stack(s) 1310 of FIG. 13.

At block 1624, the example utility evaluation circuitry 1306 forwards the data packet. For example, the egress circuitry 1414 forwards and/or sends the data packet to the corresponding software stack(s) 1310. In some examples, the egress circuitry 1414 provides the data packet to one or more example queues (e.g., ADQs) mapped to the utility function and/or identified by the example ADQ mapping circuitry 1408 of FIG. 14 based on the payload of the data packet.

At block 1626, the example utility evaluation circuitry 1306 determines whether a doorbell event has been detected. For example, the example doorbell execution circuitry 1406 of FIG. 14 detects the doorbell event, where the doorbell event includes at least a threshold number and/or percentage of data packets being dropped, the historic information being updated at least a threshold number of times, the amount of memory used to store the historic information being at or above a threshold amount, etc. In response to the doorbell execution circuitry 1406 detecting a doorbell event (e.g., block 1626 returning a result of YES), control proceeds to block 1628. Alternatively, in response to the doorbell execution circuitry 1406 not detecting a doorbell event (e.g., block 1626 returning a result of NO), control proceeds to block 1630.

At block 1628, the example utility evaluation circuitry 1306 generates and/or provides an example doorbell (e.g., an alert) to the software stack(s) 1310. For example, the doorbell execution circuitry 1406 generates the doorbell including historic and/or statistical information associated with one(s) of the utility functions, and provides (e.g., transmits, sends) the doorbell to the software stack(s) 1310.

At block 1630, the example utility evaluation circuitry 1306 determines whether one or more additional data packets are to be received at the NIC 1304. In response to the ingress circuitry 1402 determining that one or more additional data packets are to be received (e.g., block 1630 returns a result of YES), control returns to block 1602. Alternatively, in response to the ingress circuitry 1402 determining that no more additional data packets are to be received (e.g., block 1630 returns a result of NO), control ends.

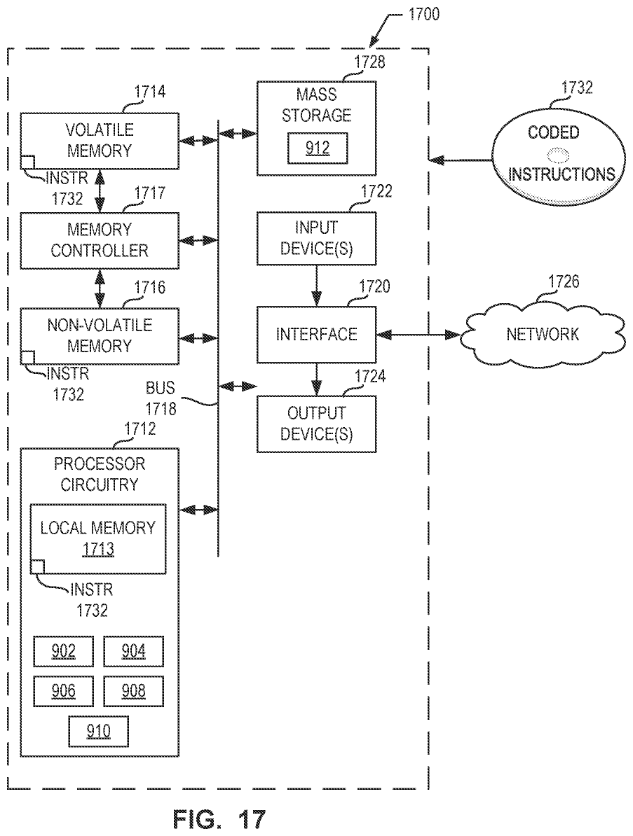

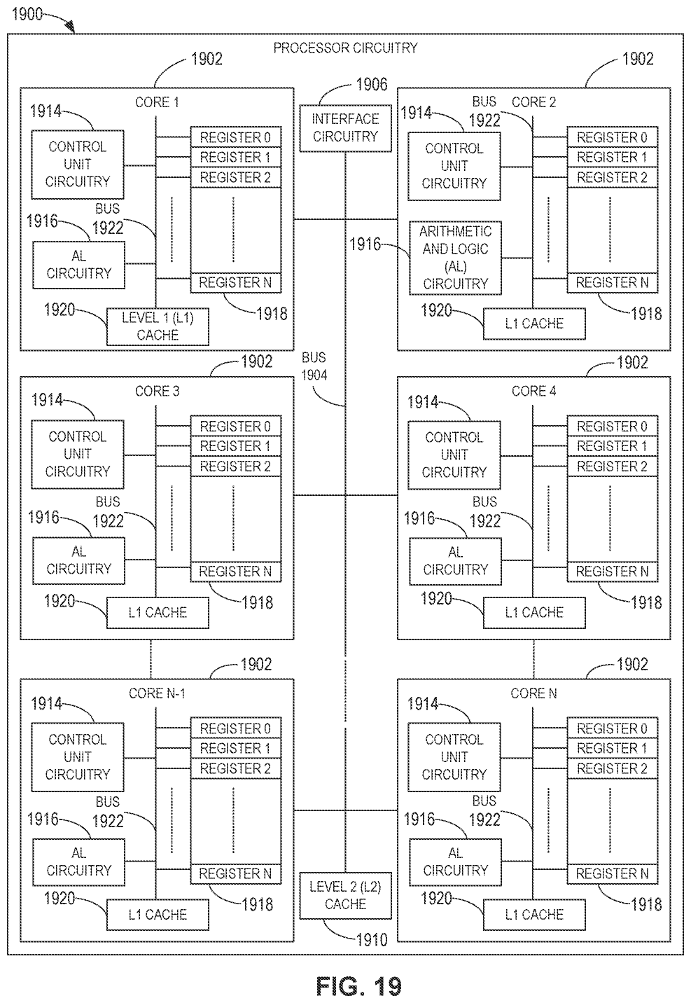

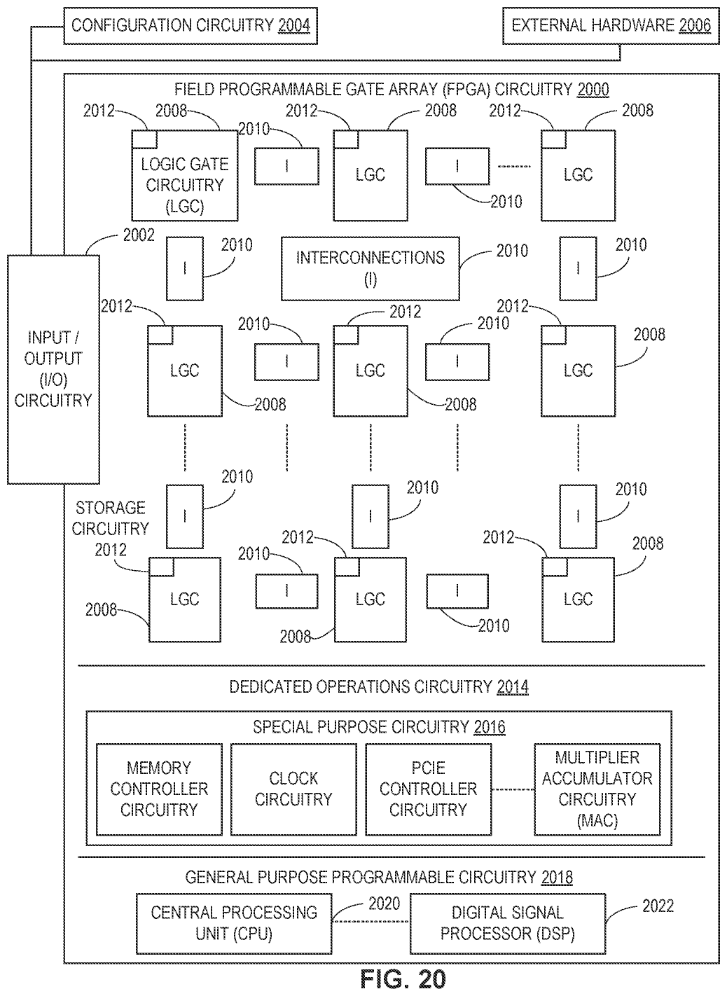

In some examples, the stream mapping circuitry 706 includes means for interfacing. For example, the means for interfacing may be implemented by the data interface circuitry 902. In some examples, the data interface circuitry 902 may be instantiated by programmable circuitry such as the example programmable circuitry 1712 of FIG. 17. For instance, the data interface circuitry 902 may be instantiated by the example microprocessor 1900 of FIG. 19 executing machine executable instructions such as those implemented by at least blocks 1208, 1222 of FIG. 12. In some examples, the data interface circuitry 902 may be instantiated by hardware logic circuitry, which may be implemented by an ASIC, XPU, or the FPGA circuitry 2000 of FIG. 20 configured and/or structured to perform operations corresponding to the machine readable instructions. Additionally or alternatively, the data interface circuitry 902 may be instantiated by any other combination of hardware, software, and/or firmware. For example, the data interface circuitry 902 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the stream mapping circuitry 706 includes means for generating an array. For example, the means for generating an array may be implemented by the array generation circuitry 904. In some examples, the array generation circuitry 904 may be instantiated by programmable circuitry such as the example programmable circuitry 1712 of FIG. 17. For instance, the array generation circuitry 904 may be instantiated by the example microprocessor 1900 of FIG. 19 executing machine executable instructions such as those implemented by at least blocks 1202, 1204 of FIG. 12. In some examples, the array generation circuitry 904 may be instantiated by hardware logic circuitry, which may be implemented by an ASIC, XPU, or the FPGA circuitry 2000 of FIG. 20 configured and/or structured to perform operations corresponding to the machine readable instructions. Additionally or alternatively, the array generation circuitry 904 may be instantiated by any other combination of hardware, software, and/or firmware. For example, the array generation circuitry 904 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the stream mapping circuitry 706 includes means for analyzing a state. For example, the means for analyzing a state may be implemented by the state analysis circuitry 906. In some examples, the state analysis circuitry 906 may be instantiated by programmable circuitry such as the example programmable circuitry 1712 of FIG. 17. For instance, the state analysis circuitry 906 may be instantiated by the example microprocessor 1900 of FIG. 19 executing machine executable instructions such as those implemented by at least blocks 1212, 1214 of FIG. 12. In some examples, the state analysis circuitry 906 may be instantiated by hardware logic circuitry, which may be implemented by an ASIC, XPU, or the FPGA circuitry 2000 of FIG. 20 configured and/or structured to perform operations corresponding to the machine readable instructions. Additionally or alternatively, the state analysis circuitry 906 may be instantiated by any other combination of hardware, software, and/or firmware. For example, the state analysis circuitry 906 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the stream mapping circuitry 706 includes means for mapping. For example, the means for mapping may be implemented by the mapping control circuitry 908. In some examples, the mapping control circuitry 908 may be instantiated by programmable circuitry such as the example programmable circuitry 1712 of FIG. 17. For instance, the mapping control circuitry 908 may be instantiated by the example microprocessor 1900 of FIG. 19 executing machine executable instructions such as those implemented by at least blocks 1206, 1210, 1216, 1218 of FIG. 12. In some examples, the mapping control circuitry 908 may be instantiated by hardware logic circuitry, which may be implemented by an ASIC, XPU, or the FPGA circuitry 2000 of FIG. 20 configured and/or structured to perform operations corresponding to the machine readable instructions. Additionally or alternatively, the mapping control circuitry 908 may be instantiated by any other combination of hardware, software, and/or firmware. For example, the mapping control circuitry 908 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the stream mapping circuitry 706 includes means for selecting a compression scheme. For example, the means for selecting a compression scheme may be implemented by the compression control circuitry 910. In some examples, the compression control circuitry 910 may be instantiated by programmable circuitry such as the example programmable circuitry 1712 of FIG. 17. For instance, the compression control circuitry 910 may be instantiated by the example microprocessor 1900 of FIG. 19 executing machine executable instructions such as those implemented by at least block 1220 of FIG. 12. In some examples, the compression control circuitry 910 may be instantiated by hardware logic circuitry, which may be implemented by an ASIC, XPU, or the FPGA circuitry 2000 of FIG. 20 configured and/or structured to perform operations corresponding to the machine readable instructions. Additionally or alternatively, the compression control circuitry 910 may be instantiated by any other combination of hardware, software, and/or firmware. For example, the compression control circuitry 910 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

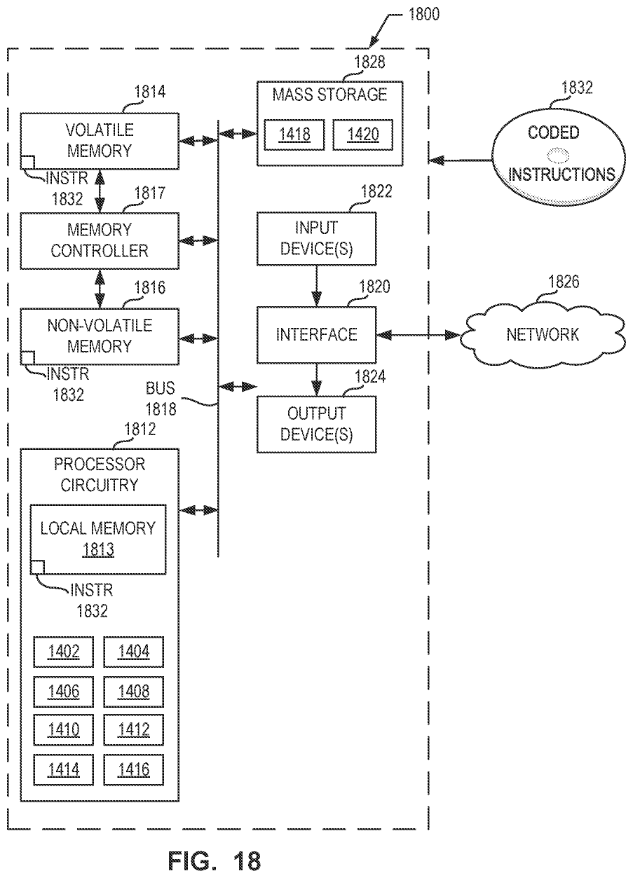

In some examples, the utility evaluation circuitry 1306 includes means for receiving. For example, the means for receiving may be implemented by the ingress circuitry 1402. In some examples, the ingress circuitry 1402 may be instantiated by programmable circuitry such as the example programmable circuitry 1812 of FIG. 18. For instance, the ingress circuitry 1402 may be instantiated by the example microprocessor 1900 of FIG. 19 executing machine executable instructions such as those implemented by at least blocks 1602, 1630 of FIG. 16. In some examples, the ingress circuitry 1402 may be instantiated by hardware logic circuitry, which may be implemented by an ASIC, XPU, or the FPGA circuitry 2000 of FIG. 20 configured and/or structured to perform operations corresponding to the machine readable instructions. Additionally or alternatively, the ingress circuitry 1402 may be instantiated by any other combination of hardware, software, and/or firmware. For example, the ingress circuitry 1402 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the utility evaluation circuitry 1306 includes means for registering. For example, the means for registering may be implemented by the registration circuitry 1404. In some examples, the registration circuitry 1404 may be instantiated by programmable circuitry such as the example programmable circuitry 1812 of FIG. 18. For instance, the registration circuitry 1404 may be instantiated by the example microprocessor 1900 of FIG. 19 executing machine executable instructions such as those implemented by at least blocks 1502, 1504, 1506, 1508, 1510, 1512, 1514 of FIG. 15. In some examples, the registration circuitry 1404 may be instantiated by hardware logic circuitry, which may be implemented by an ASIC, XPU, or the FPGA circuitry 2000 of FIG. 20 configured and/or structured to perform operations corresponding to the machine readable instructions. Additionally or alternatively, the registration circuitry 1404 may be instantiated by any other combination of hardware, software, and/or firmware. For example, the registration circuitry 1404 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the utility evaluation circuitry 1306 includes means for generating a doorbell. For example, the means for generating a doorbell may be implemented by the doorbell execution circuitry 1406. In some examples, the doorbell execution circuitry 1406 may be instantiated by programmable circuitry such as the example programmable circuitry 1812 of FIG. 18. For instance, the doorbell execution circuitry 1406 may be instantiated by the example microprocessor 1900 of FIG. 19 executing machine executable instructions such as those implemented by at least blocks 1626, 1628 of FIG. 16. In some examples, the doorbell execution circuitry 1406 may be instantiated by hardware logic circuitry, which may be implemented by an ASIC, XPU, or the FPGA circuitry 2000 of FIG. 20 configured and/or structured to perform operations corresponding to the machine readable instructions. Additionally or alternatively, the doorbell execution circuitry 1406 may be instantiated by any other combination of hardware, software, and/or firmware. For example, the doorbell execution circuitry 1406 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the utility evaluation circuitry 1306 includes means for mapping to a queue. For example, the means for mapping to a queue may be implemented by the ADQ mapping circuitry 1408. In some examples, the ADQ mapping circuitry 1408 may be instantiated by programmable circuitry such as the example programmable circuitry 1812 of FIG. 18. For instance, the ADQ mapping circuitry 1408 may be instantiated by the example microprocessor 1900 of FIG. 19 executing machine executable instructions such as those implemented by at least block 1624 of FIG. 16. In some examples, the ADQ mapping circuitry 1408 may be instantiated by hardware logic circuitry, which may be implemented by an ASIC, XPU, or the FPGA circuitry 2000 of FIG. 20 configured and/or structured to perform operations corresponding to the machine readable instructions. Additionally or alternatively, the ADQ mapping circuitry 1408 may be instantiated by any other combination of hardware, software, and/or firmware. For example, the ADQ mapping circuitry 1408 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the utility evaluation circuitry 1306 includes means for intercepting. For example, the means for intercepting may be implemented by the traffic interception circuitry 1410. In some examples, the traffic interception circuitry 1410 may be instantiated by programmable circuitry such as the example programmable circuitry 1812 of FIG. 18. For instance, the traffic interception circuitry 1410 may be instantiated by the example microprocessor 1900 of FIG. 19 executing machine executable instructions such as those implemented by at least blocks 1604, 1606 of FIG. 16. In some examples, the traffic interception circuitry 1410 may be instantiated by hardware logic circuitry, which may be implemented by an ASIC, XPU, or the FPGA circuitry 2000 of FIG. 20 configured and/or structured to perform operations corresponding to the machine readable instructions. Additionally or alternatively, the traffic interception circuitry 1410 may be instantiated by any other combination of hardware, software, and/or firmware. For example, the traffic interception circuitry 1410 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the utility evaluation circuitry 1306 includes means for processing historic information. For example, the means for processing historic information may be implemented by the historic processing circuitry 1412. In some examples, the historic processing circuitry 1412 may be instantiated by programmable circuitry such as the example programmable circuitry 1812 of FIG. 18. For instance, the historic processing circuitry 1412 may be instantiated by the example microprocessor 1900 of FIG. 19 executing machine executable instructions such as those implemented by at least block 1618 of FIG. 16. In some examples, the historic processing circuitry 1412 may be instantiated by hardware logic circuitry, which may be implemented by an ASIC, XPU, or the FPGA circuitry 2000 of FIG. 20 configured and/or structured to perform operations corresponding to the machine readable instructions. Additionally or alternatively, the historic processing circuitry 1412 may be instantiated by any other combination of hardware, software, and/or firmware. For example, the historic processing circuitry 1412 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the utility evaluation circuitry 1306 includes means for sending. For example, the means for sending may be implemented by the egress circuitry 1414. In some examples, the egress circuitry 1414 may be instantiated by programmable circuitry such as the example programmable circuitry 1812 of FIG. 18. For instance, the egress circuitry 1414 may be instantiated by the example microprocessor 1900 of FIG. 19 executing machine executable instructions such as those implemented by at least blocks 1620, 1622, 1624 of FIG. 16. In some examples, the egress circuitry 1414 may be instantiated by hardware logic circuitry, which may be implemented by an ASIC, XPU, or the FPGA circuitry 2000 of FIG. 20 configured and/or structured to perform operations corresponding to the machine readable instructions. Additionally or alternatively, the egress circuitry 1414 may be instantiated by any other combination of hardware, software, and/or firmware. For example, the egress circuitry 1414 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the utility evaluation circuitry 1306 includes means for executing. For example, the means for executing may be implemented by the function execution circuitry 1416. In some examples, the function execution circuitry 1416 may be instantiated by programmable circuitry such as the example programmable circuitry 1812 of FIG. 18. For instance, the function execution circuitry 1416 may be instantiated by the example microprocessor 1900 of FIG. 19 executing machine executable instructions such as those implemented by at least blocks 1608, 1610, 1612, 1614, 1616 of FIG. 16. In some examples, the function execution circuitry 1416 may be instantiated by hardware logic circuitry, which may be implemented by an ASIC, XPU, or the FPGA circuitry 2000 of FIG. 20 configured and/or structured to perform operations corresponding to the machine readable instructions. Additionally or alternatively, the function execution circuitry 1416 may be instantiated by any other combination of hardware, software, and/or firmware. For example, the function execution circuitry 1416 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the stream mapping circuitry 706 of FIG. 7 is illustrated in FIG. 9, one or more of the elements, processes, and/or devices illustrated in FIG. 9 may be combined, divided, re-arranged, omitted, eliminated, and/or implemented in any other way. Further, the example data interface circuitry 902, the example array generation circuitry 904, the example state analysis circuitry 906, the example mapping control circuitry 908, the example compression control circuitry 910, the example mapping database 912, and/or, more generally, the example stream mapping circuitry 706 of FIG. 9, may be implemented by hardware alone or by hardware in combination with software and/or firmware. Thus, for example, any of the example data interface circuitry 902, the example array generation circuitry 904, the example state analysis circuitry 906, the example mapping control circuitry 908, the example compression control circuitry 910, the example mapping database 912, and/or, more generally, the example stream mapping circuitry 706, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example stream mapping circuitry 706 of FIG. 9 may include one or more elements, processes, and/or devices in addition to, or instead of, those illustrated in FIG. 9, and/or may include more than one of any or all of the illustrated elements, processes and devices.

While an example manner of implementing the utility evaluation circuitry 1306 of FIG. 13 is illustrated in FIG. 14, one or more of the elements, processes, and/or devices illustrated in FIG. 14 may be combined, divided, re-arranged, omitted, eliminated, and/or implemented in any other way. Further, the example ingress circuitry 1402, the example registration circuitry 1404, the example doorbell execution circuitry 1406, the example ADQ mapping circuitry 1408, the example traffic intercept circuitry 1410, the example historic processing circuitry 1412, the example egress circuitry 1414, the example function execution circuitry 1416, the example function database 1418, the example historic database 1420, and/or, more generally, the example utility evaluation circuitry 1306 of FIG. 14, may be implemented by hardware alone or by hardware in combination with software and/or firmware. Thus, for example, any of the example ingress circuitry 1402, the example registration circuitry 1404, the example doorbell execution circuitry 1406, the example ADQ mapping circuitry 1408, the example traffic intercept circuitry 1410, the example historic processing circuitry 1412, the example egress circuitry 1414, the example function execution circuitry 1416, the example function database 1418, the example historic database 1420, and/or, more generally, the example utility evaluation circuitry 1306, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example utility evaluation circuitry 1306 of FIG. 14 may include one or more elements, processes, and/or devices in addition to, or instead of, those illustrated in FIG. 14, and/or may include more than one of any or all of the illustrated elements, processes and devices.

Flowchart(s) representative of example machine readable instructions, which may be executed by programmable circuitry to implement and/or instantiate the stream mapping circuitry 706 of FIG. 9 and/or the utility evaluation circuitry 1306 of FIG. 14 and/or representative of example operations which may be performed by programmable circuitry to implement and/or instantiate the stream mapping circuitry 706 of FIG. 9 and/or the utility evaluation circuitry 1306 of FIG. 14, are shown in FIGS. 12, 15, and/or 16. The machine readable instructions may be one or more executable programs or portion(s) of one or more executable programs for execution by programmable circuitry such as the programmable circuitry 1712 shown in the example processor platform 1700 discussed below in connection with FIG. 17 and/or the programmable circuitry 1812 shown in the example processor platform 1800 discussed below in connection with FIG. 18 and/or may be one or more function(s) or portion(s) of functions to be performed by the example programmable circuitry (e.g., an FPGA) discussed below in connection with FIGS. 19 and/or 20. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 12, 15, and/or 16, many other methods of implementing the example stream mapping circuitry 706 and/or the utility evaluation circuitry 1306 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 12, 15, and/or 16 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

FIG. 17 is a block diagram of an example programmable circuitry platform 1700 structured to execute and/or instantiate the example machine-readable instructions and/or the example operations of FIG. 12 to implement the stream mapping circuitry 706 of FIG. 9. The programmable circuitry platform 1700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1700 of the illustrated example includes programmable circuitry 1712. The programmable circuitry 1712 of the illustrated example is hardware. For example, the programmable circuitry 1712 can be implemented by one or more integrated circuits, logic circuits, FPGAs, microprocessors, CPUs, GPUs, DSPs, and/or microcontrollers from any desired family or manufacturer. The programmable circuitry 1712 may be implemented by one or more semiconductor based (e.g., silicon based) devices. In this example, the programmable circuitry 1712 implements the example data interface circuitry 902, the example array generation circuitry 904, the example state analysis circuitry 906, the example mapping control circuitry 908, the example compression control circuitry 910, and the example mapping database 912.

The programmable circuitry 1712 of the illustrated example includes a local memory 1713 (e.g., a cache, registers, etc.). The programmable circuitry 1712 of the illustrated example is in communication with main memory 1714, 1716, which includes a volatile memory 1714 and a non-volatile memory 1716, by a bus 1718. The volatile memory 1714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1716 may be implemented by flash memory and/or any other desired type of memory device. Access to the main memory 1714, 1716 of the illustrated example is controlled by a memory controller 1717. In some examples, the memory controller 1717 may be implemented by one or more integrated circuits, logic circuits, microcontrollers from any desired family or manufacturer, or any other type of circuitry to manage the flow of data going to and from the main memory 1714, 1716.

The programmable circuitry platform 1700 of the illustrated example also includes interface circuitry 1720. The interface circuitry 1720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1722 are connected to the interface circuitry 1720. The input device(s) 1722 permit(s) a user (e.g., a human user, a machine user, etc.) to enter data and/or commands into the programmable circuitry 1712. The input device(s) 1722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1724 are also connected to the interface circuitry 1720 of the illustrated example. The output device(s) 1724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1720 of the illustrated example, thus, typically includes a graphics driver card, a graphics driver chip, and/or graphics processor circuitry such as a GPU.

The interface circuitry 1720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1700 of the illustrated example also includes one or more mass storage discs or devices 1728 to store firmware, software, and/or data. Examples of such mass storage discs or devices 1728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1732, which may be implemented by the machine readable instructions of FIG. 12, may be stored in the mass storage device 1728, in the volatile memory 1714, in the non-volatile memory 1716, and/or on at least one non-transitory computer readable storage medium such as a CD or DVD which may be removable.

FIG. 18 is a block diagram of an example programmable circuitry platform 1800 structured to execute and/or instantiate the example machine-readable instructions and/or the example operations of FIGS. 15 and/or 16 to implement the utility evaluation circuitry 1306 of FIG. 14. The programmable circuitry platform 1800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1800 of the illustrated example includes programmable circuitry 1812. The programmable circuitry 1812 of the illustrated example is hardware. For example, the programmable circuitry 1812 can be implemented by one or more integrated circuits, logic circuits, FPGAs, microprocessors, CPUs, GPUs, DSPs, and/or microcontrollers from any desired family or manufacturer. The programmable circuitry 1812 may be implemented by one or more semiconductor based (e.g., silicon based) devices. In this example, the programmable circuitry 1812 implements the example ingress circuitry 1402, the example registration circuitry 1404, the example doorbell execution circuitry 1406, the example ADQ mapping circuitry 1408, the example traffic intercept circuitry 1410, the example historic processing circuitry 1412, the example egress circuitry 1414, the example function execution circuitry 1416, the example function database 1418, and the example historic database 1420.

The programmable circuitry 1812 of the illustrated example includes a local memory 1813 (e.g., a cache, registers, etc.). The programmable circuitry 1812 of the illustrated example is in communication with main memory 1814, 1816, which includes a volatile memory 1814 and a non-volatile memory 1816, by a bus 1818. The volatile memory 1814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1816 may be implemented by flash memory and/or any other desired type of memory device. Access to the main memory 1814, 1816 of the illustrated example is controlled by a memory controller 1817. In some examples, the memory controller 1817 may be implemented by one or more integrated circuits, logic circuits, microcontrollers from any desired family or manufacturer, or any other type of circuitry to manage the flow of data going to and from the main memory 1814, 1816.

The programmable circuitry platform 1800 of the illustrated example also includes interface circuitry 1820. The interface circuitry 1820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1822 are connected to the interface circuitry 1820. The input device(s) 1822 permit(s) a user (e.g., a human user, a machine user, etc.) to enter data and/or commands into the programmable circuitry 1812. The input device(s) 1822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1824 are also connected to the interface circuitry 1820 of the illustrated example. The output device(s) 1824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1820 of the illustrated example, thus, typically includes a graphics driver card, a graphics driver chip, and/or graphics processor circuitry such as a GPU.

The interface circuitry 1820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1800 of the illustrated example also includes one or more mass storage discs or devices 1828 to store firmware, software, and/or data. Examples of such mass storage discs or devices 1828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1832, which may be implemented by the machine readable instructions of FIGS. 15 and/or 16, may be stored in the mass storage device 1828, in the volatile memory 1814, in the non-volatile memory 1816, and/or on at least one non-transitory computer readable storage medium such as a CD or DVD which may be removable.

FIG. 19 is a block diagram of an example implementation of the programmable circuitry 1712 of FIG. 17 and/or the programmable circuitry 1812 of FIG. 18. In this example, the programmable circuitry 1712 of FIG. 17 and/or the programmable circuitry 1812 of FIG. 18 is implemented by a microprocessor 1900. For example, the microprocessor 1900 may be a general-purpose microprocessor (e.g., general-purpose microprocessor circuitry). The microprocessor 1900 executes some or all of the machine-readable instructions of the flowcharts of FIGS. 12, 15, and/or 16 to effectively instantiate the circuitry of FIGS. 9 and/or 14 as logic circuits to perform operations corresponding to those machine readable instructions. In some such examples, the circuitry of FIGS. 9 and/or 14 is instantiated by the hardware circuits of the microprocessor 1900 in combination with the machine-readable instructions. For example, the microprocessor 1900 may be implemented by multi-core hardware circuitry such as a CPU, a DSP, a GPU, an XPU, etc. Although it may include any number of example cores 1902 (e.g., 1 core), the microprocessor 1900 of this example is a multi-core semiconductor device including N cores. The cores 1902 of the microprocessor 1900 may operate independently or may cooperate to execute machine readable instructions. For example, machine code corresponding to a firmware program, an embedded software program, or a software program may be executed by one of the cores 1902 or may be executed by multiple ones of the cores 1902 at the same or different times. In some examples, the machine code corresponding to the firmware program, the embedded software program, or the software program is split into threads and executed in parallel by two or more of the cores 1902. The software program may correspond to a portion or all of the machine readable instructions and/or operations represented by the flowcharts of FIGS. 12, 15, and/or 16.

The cores 1902 may communicate by a first example bus 1904. In some examples, the first bus 1904 may be implemented by a communication bus to effectuate communication associated with one(s) of the cores 1902. For example, the first bus 1904 may be implemented by at least one of an Inter-Integrated Circuit (I2C) bus, a Serial Peripheral Interface (SPI) bus, a PCI bus, or a PCIe bus. Additionally or alternatively, the first bus 1904 may be implemented by any other type of computing or electrical bus. The cores 1902 may obtain data, instructions, and/or signals from one or more external devices by example interface circuitry 1906. The cores 1902 may output data, instructions, and/or signals to the one or more external devices by the interface circuitry 1906. Although the cores 1902 of this example include example local memory 1920 (e.g., Level 1 (L1) cache that may be split into an L1 data cache and an L1 instruction cache), the microprocessor 1900 also includes example shared memory 1910 that may be shared by the cores (e.g., Level 2 (L2 cache)) for high-speed access to data and/or instructions. Data and/or instructions may be transferred (e.g., shared) by writing to and/or reading from the shared memory 1910. The local memory 1920 of each of the cores 1902 and the shared memory 1910 may be part of a hierarchy of storage devices including multiple levels of cache memory and the main memory (e.g., the main memory 1714, 1716 of FIG. 17 and/or the main memory 1814, 1816 of FIG. 18). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1902 may be referred to as a CPU, DSP, GPU, etc., or any other type of hardware circuitry. Each core 1902 includes control unit circuitry 1914, arithmetic and logic (AL) circuitry (sometimes referred to as an ALU) 1916, a plurality of registers 1918, the local memory 1920, and a second example bus 1922. Other structures may be present. For example, each core 1902 may include vector unit circuitry, single instruction multiple data (SIMD) unit circuitry, load/store unit (LSU) circuitry, branch/jump unit circuitry, floating-point unit (FPU) circuitry, etc. The control unit circuitry 1914 includes semiconductor-based circuits structured to control (e.g., coordinate) data movement within the corresponding core 1902. The AL circuitry 1916 includes semiconductor-based circuits structured to perform one or more mathematic and/or logic operations on the data within the corresponding core 1902. The AL circuitry 1916 of some examples performs integer based operations. In other examples, the AL circuitry 1916 also performs floating-point operations. In yet other examples, the AL circuitry 1916 may include first AL circuitry that performs integer-based operations and second AL circuitry that performs floating-point operations. In some examples, the AL circuitry 1916 may be referred to as an Arithmetic Logic Unit (ALU).

The registers 1918 are semiconductor-based structures to store data and/or instructions such as results of one or more of the operations performed by the AL circuitry 1916 of the corresponding core 1902. For example, the registers 1918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1918 may be arranged in a bank as shown in FIG. 19. Alternatively, the registers 1918 may be organized in any other arrangement, format, or structure, such as by being distributed throughout the core 1902 to shorten access time. The second bus 1922 may be implemented by at least one of an I2C bus, a SPI bus, a PCI bus, or a PCIe bus.

Each core 1902 and/or, more generally, the microprocessor 1900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1900 is a semiconductor device fabricated to include many transistors interconnected to implement the structures described above in one or more integrated circuits (ICs) contained in one or more packages.

The microprocessor 1900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1900, in the same chip package as the microprocessor 1900 and/or in one or more separate packages from the microprocessor 1900.

FIG. 20 is a block diagram of another example implementation of the programmable circuitry 1712 of FIG. 17 and/or the programmable circuitry 1812 of FIG. 18. In this example, the programmable circuitry 1712 and/or the programmable circuitry 1812 is implemented by FPGA circuitry 2000. For example, the FPGA circuitry 2000 may be implemented by an FPGA. The FPGA circuitry 2000 can be used, for example, to perform operations that could otherwise be performed by the example microprocessor 1900 of FIG. 19 executing corresponding machine readable instructions. However, once configured, the FPGA circuitry 2000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1900 of FIG. 19 described above (which is a general purpose device that may be programmed to execute some or all of the machine readable instructions represented by the flowchart(s) of FIGS. 12, 15, and/or 16 but whose interconnections and logic circuitry are fixed once fabricated), the FPGA circuitry 2000 of the example of FIG. 20 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 12, 15, and/or 16. In particular, the FPGA circuitry 2000 may be thought of as an array of logic gates, interconnections, and switches. The switches can be programmed to change how the logic gates are interconnected by the interconnections, effectively forming one or more dedicated logic circuits (unless and until the FPGA circuitry 2000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 12, 15, and/or 16. As such, the FPGA circuitry 2000 may be configured and/or structured to effectively instantiate some or all of the operations/functions corresponding to the machine readable instructions of the flowchart(s) of FIGS. 12, 15, and/or 16 as dedicated logic circuits to perform the operations/functions corresponding to those software instructions in a dedicated manner analogous to an ASIC. Therefore, the FPGA circuitry 2000 may perform the operations/functions corresponding to the some or all of the machine readable instructions of FIGS. 12, 15, and/or 16 faster than the general-purpose microprocessor can execute the same.

In the example of FIG. 20, the FPGA circuitry 2000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 2000 of FIG. 20 may access and/or load the binary file to cause the FPGA circuitry 2000 of FIG. 20 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 2000 of FIG. 20 to cause configuration and/or structuring of the FPGA circuitry 2000 of FIG. 20, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 2000 of FIG. 20 may access and/or load the binary file to cause the FPGA circuitry 2000 of FIG. 20 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 2000 of FIG. 20 to cause configuration and/or structuring of the FPGA circuitry 2000 of FIG. 20, or portion(s) thereof.

The FPGA circuitry 2000 of FIG. 20, includes example input/output (I/O) circuitry 2002 to obtain and/or output data to/from example configuration circuitry 2004 and/or external hardware 2006. For example, the configuration circuitry 2004 may be implemented by interface circuitry that may obtain a binary file, which may be implemented by a bit stream, data, and/or machine-readable instructions, to configure the FPGA circuitry 2000, or portion(s) thereof. In some such examples, the configuration circuitry 2004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 2006 may be implemented by external hardware circuitry. For example, the external hardware 2006 may be implemented by the microprocessor 1900 of FIG. 19.

The FPGA circuitry 2000 also includes an array of example logic gate circuitry 2008, a plurality of example configurable interconnections 2010, and example storage circuitry 2012. The logic gate circuitry 2008 and the configurable interconnections 2010 are configurable to instantiate one or more operations/functions that may correspond to at least some of the machine readable instructions of FIGS. 12, 15, and/or 16 and/or other desired operations. The logic gate circuitry 2008 shown in FIG. 20 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2008 to enable configuration of the electrical structures and/or the logic gates to form circuits to perform desired operations/functions. The logic gate circuitry 2008 may include other electrical structures such as look-up tables (LUTs), registers (e.g., flip-flops or latches), multiplexers, etc.

The configurable interconnections 2010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2008 to program desired logic circuits.

The storage circuitry 2012 of the illustrated example is structured to store result(s) of the one or more of the operations performed by corresponding logic gates. The storage circuitry 2012 may be implemented by registers or the like. In the illustrated example, the storage circuitry 2012 is distributed amongst the logic gate circuitry 2008 to facilitate access and increase execution speed.

The example FPGA circuitry 2000 of FIG. 20 also includes example dedicated operations circuitry 2014. In this example, the dedicated operations circuitry 2014 includes special purpose circuitry 2016 that may be invoked to implement commonly used functions to avoid the need to program those functions in the field. Examples of such special purpose circuitry 2016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2000 may also include example general purpose programmable circuitry 2018 such as an example CPU 2020 and/or an example DSP 2022. Other general purpose programmable circuitry 2018 may additionally or alternatively be present such as a GPU, an XPU, etc., that can be programmed to perform other operations.

Although FIGS. 19 and 20 illustrate two example implementations of the programmable circuitry 1712 of FIG. 17 and/or the programmable circuitry 1812 of FIG. 18, many other approaches are contemplated. For example, FPGA circuitry may include an on-board CPU, such as one or more of the example CPU 2020 of FIG. 19. Therefore, the programmable circuitry 1712 of FIG. 17 and/or the programmable circuitry 1812 of FIG. 18 may additionally be implemented by combining at least the example microprocessor 1900 of FIG. 19 and the example FPGA circuitry 2000 of FIG. 20. In some such hybrid examples, one or more cores 1902 of FIG. 19 may execute a first portion of the machine readable instructions represented by the flowchart(s) of FIGS. 12, 15, and/or 16 to perform first operation(s)/function(s), the FPGA circuitry 2000 of FIG. 20 may be configured and/or structured to perform second operation(s)/function(s) corresponding to a second portion of the machine readable instructions represented by the flowcharts of FIGS. 12, 15, and/or 16, and/or an ASIC may be configured and/or structured to perform third operation(s)/function(s) corresponding to a third portion of the machine readable instructions represented by the flowcharts of FIGS. 12, 15, and/or 16.

It should be understood that some or all of the circuitry of FIGS. 9 and/or 14 may, thus, be instantiated at the same or different times. For example, same and/or different portion(s) of the microprocessor 1900 of FIG. 19 may be programmed to execute portion(s) of machine-readable instructions at the same and/or different times. In some examples, same and/or different portion(s) of the FPGA circuitry 2000 of FIG. 20 may be configured and/or structured to perform operations/functions corresponding to portion(s) of machine-readable instructions at the same and/or different times.

In some examples, some or all of the circuitry of FIGS. 9 and/or 14 may be instantiated, for example, in one or more threads executing concurrently and/or in series. For example, the microprocessor 1900 of FIG. 19 may execute machine readable instructions in one or more threads executing concurrently and/or in series. In some examples, the FPGA circuitry 2000 of FIG. 20 may be configured and/or structured to carry out operations/functions concurrently and/or in series. Moreover, in some examples, some or all of the circuitry of FIGS. 9 and/or 14 may be implemented within one or more virtual machines and/or containers executing on the microprocessor 1900 of FIG. 19.

In some examples, the programmable circuitry 1712 of FIG. 17 and/or the programmable circuitry 1812 of FIG. 18 may be in one or more packages. For example, the microprocessor 1900 of FIG. 19 and/or the FPGA circuitry 2000 of FIG. 20 may be in one or more packages. In some examples, an XPU may be implemented by the programmable circuitry 1712 of FIG. 17 and/or the programmable circuitry 1812 of FIG. 18, which may be in one or more packages. For example, the XPU may include a CPU (e.g., the microprocessor 1900 of FIG. 19, the CPU 2020 of FIG. 20, etc.) in one package, a DSP (e.g., the DSP 2022 of FIG. 20) in another package, a GPU in yet another package, and an FPGA (e.g., the FPGA circuitry 2000 of FIG. 20) in still yet another package.

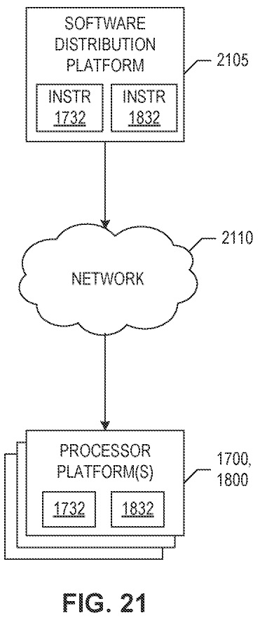

A block diagram illustrating an example software distribution platform 2105 to distribute software such as the example machine readable instructions 1732 of FIG. 17 and/or the example machine readable instructions 1832 of FIG. 18 to other hardware devices (e.g., hardware devices owned and/or operated by third parties from the owner and/or operator of the software distribution platform) is illustrated in FIG. 21. The example software distribution platform 2105 may be implemented by any computer server, data facility, cloud service, etc., capable of storing and transmitting software to other computing devices. The third parties may be customers of the entity owning and/or operating the software distribution platform 2105. For example, the entity that owns and/or operates the software distribution platform 2105 may be a developer, a seller, and/or a licensor of software such as the example machine readable instructions 1732 of FIG. 17 and/or the example machine readable instructions 1832 of FIG. 18. The third parties may be consumers, users, retailers, OEMs, etc., who purchase and/or license the software for use and/or re-sale and/or sub-licensing. In the illustrated example, the software distribution platform 2105 includes one or more servers and one or more storage devices. The storage devices store the machine readable instructions 1732 and/or the machine readable instructions 1832, which may correspond to the example machine readable instructions of FIGS. 12, 15, and/or 16, as described above. The one or more servers of the example software distribution platform 2105 are in communication with an example network 2110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1732 and/or the machine readable instructions 1832 from the software distribution platform 2105. For example, the software, which may correspond to the example machine readable instructions of FIGS. 12, 15, and/or 16, may be downloaded to the example programmable circuitry platform 1700, which is to execute the machine readable instructions 1732 to implement the stream mapping circuitry 706, and/or may be downloaded to the example programmable circuitry platform 1800, which is to execute the machine readable instructions 1832 to implement the utility evaluation circuitry 1306. In some examples, one or more servers of the software distribution platform 2105 periodically offer, transmit, and/or force updates to the software (e.g., the example machine readable instructions 1732 of FIG. 17 and/or the example machine readable instructions 1832 of FIG. 18) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that manage network communications in time sensitive networks. Examples disclosed herein execute one or more example utility functions based on a payload of a data packet from a data stream and/or based on example historic information associated with the data stream. As a result of the execution, examples disclosed herein determine an example utility value of the data packet to determine whether to drop or forward the data packet to an example platform (e.g., a server platform) and/or one or more example software stack implemented thereon. Advantageously, examples disclosed herein may reduce an amount of redundant and/or low utility data to be ingested at the platform, thus reducing computational power and/or memory usage to store and/or process incoming data. Further examples disclosed herein dynamically switch between ones of a plurality of example proxy data streams to transmit data between edge devices in a time sensitive network, where the proxy data streams are preconfigured to satisfy respective different communication metrics (e.g., bandwidth, latency, etc.). In some examples, by switching between preconfigured ones of the proxy data streams, examples disclosed herein can adapt to changing QoS demands of a network without overprovisioning of the network and/or without necessitating reallocation of communication resources and/or recalculation of possible scheduling plans for data sent via the network. Thus, disclosed systems, apparatus, articles of manufacture, and methods improve the efficiency of using a computing device by reducing an amount of computational resources and/or memory utilized to transmit and/or receive data (e.g., data packets and/or data streams) via a network. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to manage network communications in time sensitive networks are disclosed herein. Further examples and combinations thereof include the following:

Example 1 includes an apparatus comprising network interface circuitry, and platform interface circuitry to be programmed by instructions to determine whether to drop a data packet of a data stream or forward the data packet based on (a) a payload of the data packet and (b) historic information associated with the data stream, and operate on the data packet based on the determination.

Example 2 includes the apparatus of example 1, wherein the platform interface circuitry is to execute a utility function based on the payload and the historic information, a result of the execution including a utility value corresponding to the data packet, the utility value based on an amount of variability between the payload and the historic information, and determine whether to drop the data packet or forward the data packet based on the result of the execution.

Example 3 includes the apparatus of example 2, wherein the data stream is a first data stream, and the utility value is based on an amount of non-repeating information included in the payload and not included in one or more second data streams.

Example 4 includes the apparatus of example 2, wherein the platform interface circuitry is to drop the data packet when the utility value does not satisfy a utility threshold, and forward the data packet when the utility value satisfies the utility threshold.

Example 5 includes the apparatus of example 2, wherein the platform interface circuitry is to register the utility function by storing the utility function in association with at least one of a process address identifier corresponding to a software stack, a queue identifier corresponding to a network queue, or a universally unique identifier corresponding to the utility function.

Example 6 includes the apparatus of example 1, wherein the historic information includes at least one of a first number of dropped data packets associated with the data stream, a second number of forwarded data packets associated with the data stream, or characteristics corresponding to at least one of the dropped data packets or the forwarded data packets.

Example 7 includes the apparatus of example 1, wherein the platform interface circuitry is to generate an alert to a software stack in response to detection of an event, the event to include at least a threshold number of data packets of the data stream being dropped, the historic information being updated at least a threshold number of times, or an amount of memory used to store the historic information being at or above a threshold amount.

Example 8 includes an apparatus comprising network interface circuitry, and programmable circuitry to be programmed by instructions to select, based on state information for a first edge device, a first one of a plurality of proxy data streams available to the first edge device in a time-sensitive network environment, the plurality of proxy data streams preconfigured in the time-sensitive network environment to satisfy respective different communication metrics, and cause transmission of data from the first edge device to a second edge device based on the first one of the plurality of proxy data streams.

Example 9 includes the apparatus of example 8, wherein the communication metrics correspond to at least one of bandwidth or latency of data transmitted via respective ones of the plurality of proxy data streams.

Example 10 includes the apparatus of example 8, wherein the plurality of proxy data streams are preconfigured in a handshake procedure between the first edge device and a centralized network configuration node of the time-sensitive network environment, the plurality of proxy data streams preconfigured based on communication resources available to the first edge device.

Example 11 includes the apparatus of example 8, wherein the state information includes at least one of a position of an end point device associated with the first edge device, an orientation of the end point device, a distance between the end point device and an object, or an indication of whether the end point device is idle or performing an operation.

Example 12 includes the apparatus of example 11, wherein the state information is based on a data stream from the end point device.

Example 13 includes the apparatus of example 12, wherein the end point device is a camera, the data stream is a video data stream, and the programmable circuitry is to select a compression scheme for the video data stream based on the state information.

Example 14 includes the apparatus of example 8, wherein the programmable circuitry is to determine a target communication metric based on updated state information, select a second one of the plurality of proxy data streams corresponding to the target communication metric, halt transmission of the data based on the first one of the plurality of proxy data streams, and cause transmission of data from the first edge device to the second edge device based on the second one of the plurality of proxy data streams.

Example 15 includes an apparatus comprising network interface circuitry, and programmable circuitry to be programmed by instructions to determine, at a first edge device, whether to (a) drop a data packet of a data stream received at the first edge device or (b) forward the data packet to a second edge device, the determination based on a payload of the data packet and historic information associated with the data stream, based on the determination being to forward the data packet to the second edge device select, based on state information for the first edge device, a first one of a plurality of proxy data streams available to the first edge device in a time-sensitive network environment, the plurality of proxy data streams preconfigured in the time-sensitive network environment to satisfy respective different communication metrics, and cause transmission of the data packet to the second edge device based on the first one of the plurality of proxy data streams, and update the historic information based on the determination.

Example 16 includes the apparatus of example 15, wherein the programmable circuitry is to execute a utility function based on the payload and the historic information, a result of the execution including a utility value corresponding to the data packet, the utility value based on at least one of (a) an amount of variability between the payload and the historic information or (b) an amount of non-repeating information included in the payload and not included in one or more second data streams received at the second edge device, and determine whether to drop the data packet or forward the data packet based on the result of the execution.

Example 17 includes the apparatus of example 16, wherein the programmable circuitry is to drop the data packet when the utility value does not satisfy a utility threshold, and forward the data packet when the utility value satisfies the utility threshold.

Example 18 includes the apparatus of example 15, wherein the communication metrics correspond to at least one of bandwidth or latency of data transmitted via respective ones of the plurality of proxy data streams.

Example 19 includes the apparatus of example 15, wherein the programmable circuitry is to select a compression scheme for the data stream based on the state information.

Example 20 includes the apparatus of example 15, wherein the state information includes at least one of a position of an end point device associated with the first edge device, an orientation of the end point device, a distance between the end point device and an object, or an indication of whether the end point device is idle or performing an operation.

Example 21 includes a non-transitory computer readable medium comprising instructions that, when executed, cause programmable circuitry to at least determine whether to drop a data packet of a data stream or forward the data packet based on (a) a payload of the data packet and (b) historic information associated with the data stream, and operate on the data packet based on the determination.

Example 22 includes the non-transitory computer readable medium of example 21, wherein the instructions cause the programmable circuitry to execute a utility function based on the payload and the historic information, a result of the execution including a utility value corresponding to the data packet, the utility value based on an amount of variability between the payload and the historic information, and determine whether to drop the data packet or forward the data packet based on the result of the execution.

Example 23 includes the non-transitory computer readable medium of example 22, wherein the data stream is a first data stream, and the utility value is based on an amount of non-repeating information included in the payload and not included in one or more second data streams.

Example 24 includes the non-transitory computer readable medium of example 22, wherein the instructions cause the programmable circuitry to drop the data packet when the utility value does not satisfy a utility threshold, and forward the data packet when the utility value satisfies the utility threshold.

Example 25 includes the non-transitory computer readable medium of example 22, wherein the instructions cause the programmable circuitry to register the utility function by storing the utility function in association with at least one of a process address identifier corresponding to a software stack, a queue identifier corresponding to a network queue, or a universally unique identifier corresponding to the utility function.

Example 26 includes the non-transitory computer readable medium of example 21, wherein the historic information includes at least one of a first number of dropped data packets associated with the data stream, a second number of forwarded data packets associated with the data stream, or characteristics corresponding to at least one of the dropped data packets or the forwarded data packets.

Example 27 includes the non-transitory computer readable medium of example 21, wherein the instructions cause the programmable circuitry to generate an alert to a software stack in response to detection of an event, the event to include at least a threshold number of data packets of the data stream being dropped, the historic information being updated at least a threshold number of times, or an amount of memory used to store the historic information being at or above a threshold amount.

Example 28 includes a non-transitory computer readable medium comprising instructions that, when executed, cause programmable circuitry to at least select, based on state information for a first edge device, a first one of a plurality of proxy data streams available to the first edge device in a time-sensitive network environment, the plurality of proxy data streams preconfigured in the time-sensitive network environment to satisfy respective different communication metrics, and cause transmission of data from the first edge device to a second edge device based on the first one of the plurality of proxy data streams.

Example 29 includes the non-transitory computer readable medium of example 28, wherein the communication metrics correspond to at least one of bandwidth or latency of data transmitted via respective ones of the plurality of proxy data streams.

Example 30 includes the non-transitory computer readable medium of example 28, wherein the plurality of proxy data streams are preconfigured in a handshake procedure between the first edge device and a centralized network configuration node of the time-sensitive network environment, the plurality of proxy data streams preconfigured based on communication resources available to the first edge device.

Example 31 includes the non-transitory computer readable medium of example 28, wherein the state information includes at least one of a position of an end point device associated with the first edge device, an orientation of the end point device, a distance between the end point device and an object, or an indication of whether the end point device is idle or performing an operation.

Example 32 includes the non-transitory computer readable medium of example 31, wherein the state information is based on a data stream from the end point device.

Example 33 includes the non-transitory computer readable medium of example 32, wherein the end point device is a camera, the data stream is a video data stream, and the programmable circuitry is to select a compression scheme for the video data stream based on the state information.

Example 34 includes the non-transitory computer readable medium of example 28, wherein the instructions cause the programmable circuitry to determine a target communication metric based on updated state information, select a second one of the plurality of proxy data streams corresponding to the target communication metric, halt transmission of the data based on the first one of the plurality of proxy data streams, and cause transmission of data from the first edge device to the second edge device based on the second one of the plurality of proxy data streams.

Example 35 includes a non-transitory computer readable medium comprising instructions that, when executed, cause programmable circuitry to at least determine, at a first edge device, whether to (a) drop a data packet of a data stream received at the first edge device or (b) forward the data packet to a second edge device, the determination based on a payload of the data packet and historic information associated with the data stream, based on the determination being to forward the data packet to the second edge device select, based on state information for the first edge device, a first one of a plurality of proxy data streams available to the first edge device in a time-sensitive network environment, the plurality of proxy data streams preconfigured in the time-sensitive network environment to satisfy respective different communication metrics, and cause transmission of the data packet to the second edge device based on the first one of the plurality of proxy data streams, and update the historic information based on the determination.

Example 36 includes the non-transitory computer readable medium of example 35, wherein the instructions cause the programmable circuitry to execute a utility function based on the payload and the historic information, a result of the execution including a utility value corresponding to the data packet, the utility value based on at least one of (a) an amount of variability between the payload and the historic information or (b) an amount of non-repeating information included in the payload and not included in one or more second data streams received at the second edge device, and determine whether to drop the data packet or forward the data packet based on the result of the execution.

Example 37 includes the non-transitory computer readable medium of example 36, wherein the instructions cause the programmable circuitry to drop the data packet when the utility value does not satisfy a utility threshold, and forward the data packet when the utility value satisfies the utility threshold.

Example 38 includes the non-transitory computer readable medium of example wherein the communication metrics correspond to at least one of bandwidth or latency of data transmitted via respective ones of the plurality of proxy data streams.

Example 39 includes the non-transitory computer readable medium of example wherein the instructions cause the programmable circuitry to select a compression scheme for the data stream based on the state information.

Example 40 includes the non-transitory computer readable medium of example wherein the state information includes at least one of a position of an end point device associated with the first edge device, an orientation of the end point device, a distance between the end point device and an object, or an indication of whether the end point device is idle or performing an operation.

Example 41 includes a method comprising determining whether to drop a data packet of a data stream or forward the data packet based on (a) a payload of the data packet and (b) historic information associated with the data stream, and operating on the data packet based on the determination.

Example 42 includes the method of example 41, further including executing a utility function based on the payload and the historic information, a result of the execution including a utility value corresponding to the data packet, the utility value based on an amount of variability between the payload and the historic information, and determining whether to drop the data packet or forward the data packet based on the result of the execution.

Example 43 includes the method of example 42, wherein the data stream is a first data stream, and the utility value is based on an amount of non-repeating information included in the payload and not included in one or more second data streams.

Example 44 includes the method of example 42, further including dropping the data packet when the utility value does not satisfy a utility threshold, and forwarding the data packet when the utility value satisfies the utility threshold.

Example 45 includes the method of example 42, further including registering the utility function by storing the utility function in association with at least one of a process address identifier corresponding to a software stack, a queue identifier corresponding to a network queue, or a universally unique identifier corresponding to the utility function.

Example 46 includes the method of example 41, wherein the historic information includes at least one of a first number of dropped data packets associated with the data stream, a second number of forwarded data packets associated with the data stream, or characteristics corresponding to at least one of the dropped data packets or the forwarded data packets.

Example 47 includes the method of example 41, further including generating an alert to a software stack in response to detection of an event, the event to include at least a threshold number of data packets of the data stream being dropped, the historic information being updated at least a threshold number of times, or an amount of memory used to store the historic information being at or above a threshold amount.

Example 48 includes a method comprising selecting, based on state information for a first edge device, a first one of a plurality of proxy data streams available to the first edge device in a time-sensitive network environment, the plurality of proxy data streams preconfigured in the time-sensitive network environment to satisfy respective different communication metrics, and causing transmission of data from the first edge device to a second edge device based on the first one of the plurality of proxy data streams.

Example 49 includes the method of example 48, wherein the communication metrics correspond to at least one of bandwidth or latency of data transmitted via respective ones of the plurality of proxy data streams.

Example 50 includes the method of example 48, wherein the plurality of proxy data streams are preconfigured in a handshake procedure between the first edge device and a centralized network configuration node of the time-sensitive network environment, the plurality of proxy data streams preconfigured based on communication resources available to the first edge device.

Example 51 includes the method of example 48, wherein the state information includes at least one of a position of an end point device associated with the first edge device, an orientation of the end point device, a distance between the end point device and an object, or an indication of whether the end point device is idle or performing an operation.

Example 52 includes the method of example 51, wherein the state information is based on a data stream from the end point device.

Example 53 includes the method of example 52, wherein the end point device is a camera, the data stream is a video data stream, and further including selecting a compression scheme for the video data stream based on the state information.

Example 54 includes the method of example 48, further including determining a target communication metric based on updated state information, selecting a second one of the plurality of proxy data streams corresponding to the target communication metric, halting transmission of the data based on the first one of the plurality of proxy data streams, and causing transmission of data from the first edge device to the second edge device based on the second one of the plurality of proxy data streams.

Example 55 includes a method comprising determining, at a first edge device, whether to (a) drop a data packet of a data stream received at the first edge device or (b) forward the data packet to a second edge device, the determination based on a payload of the data packet and historic information associated with the data stream, based on the determination being to forward the data packet to the second edge device selecting, based on state information for the first edge device, a first one of a plurality of proxy data streams available to the first edge device in a time-sensitive network environment, the plurality of proxy data streams preconfigured in the time-sensitive network environment to satisfy respective different communication metrics, and causing transmission of the data packet to the second edge device based on the first one of the plurality of proxy data streams, and updating the historic information based on the determination.

Example 56 includes the method of example 55, further including executing a utility function based on the payload and the historic information, a result of the execution including a utility value corresponding to the data packet, the utility value based on at least one of (a) an amount of variability between the payload and the historic information or (b) an amount of non-repeating information included in the payload and not included in one or more second data streams received at the second edge device, and determining whether to drop the data packet or forward the data packet based on the result of the execution.

Example 57 includes the method of example 56, further including dropping the data packet when the utility value does not satisfy a utility threshold, and forwarding the data packet when the utility value satisfies the utility threshold.

Example 58 includes the method of example 55, wherein the communication metrics correspond to at least one of bandwidth or latency of data transmitted via respective ones of the plurality of proxy data streams.

Example 59 includes the method of example 55, further including selecting a compression scheme for the data stream based on the state information.

Example 60 includes the method of example 55, wherein the state information includes at least one of a position of an end point device associated with the first edge device, an orientation of the end point device, a distance between the end point device and an object, or an indication of whether the end point device is idle or performing an operation.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
network interface circuitry; and
platform interface circuitry to be programmed by instructions to:
determine whether to drop a data packet of a data stream or forward the data packet based on (a) a payload of the data packet and (b) historic information associated with the data stream; and
operate on the data packet based on the determination.

2. The apparatus of claim 1, wherein the platform interface circuitry is to:
execute a utility function based on the payload and the historic information, a result of the execution including a utility value corresponding to the data packet, the utility value based on an amount of variability between the payload and the historic information; and
determine whether to drop the data packet or forward the data packet based on the result of the execution.

3. The apparatus of claim 2, wherein the data stream is a first data stream, and the utility value is based on an amount of non-repeating information included in the payload and not included in one or more second data streams.

4. The apparatus of claim 2, wherein the platform interface circuitry is to:
drop the data packet when the utility value does not satisfy a utility threshold; and
forward the data packet when the utility value satisfies the utility threshold.

5. The apparatus of claim 2, wherein the platform interface circuitry is to register the utility function by storing the utility function in association with at least one of a process address identifier corresponding to a software stack, a queue identifier corresponding to a network queue, or a universally unique identifier corresponding to the utility function.

6. The apparatus of claim 1, wherein the historic information includes at least one of a first number of dropped data packets associated with the data stream, a second number of forwarded data packets associated with the data stream, or characteristics corresponding to at least one of the dropped data packets or the forwarded data packets.

7. The apparatus of claim 1, wherein the platform interface circuitry is to generate an alert to a software stack in response to detection of an event, the event to include at least a threshold number of data packets of the data stream being dropped, the historic information being updated at least a threshold number of times, or an amount of memory used to store the historic information being at or above a threshold amount.

8. An apparatus comprising:
network interface circuitry; and
programmable circuitry to be programmed by instructions to:
select, based on state information for a first edge device, a first one of a plurality of proxy data streams available to the first edge device in a time-sensitive network environment, the plurality of proxy data streams preconfigured in the time-sensitive network environment to satisfy respective different communication metrics; and
cause transmission of data from the first edge device to a second edge device based on the first one of the plurality of proxy data streams.

9. The apparatus of claim 8, wherein the communication metrics correspond to at least one of bandwidth or latency of data transmitted via respective ones of the plurality of proxy data streams.

10. The apparatus of claim 8, wherein the plurality of proxy data streams are preconfigured in a handshake procedure between the first edge device and a centralized network configuration node of the time-sensitive network environment, the plurality of proxy data streams preconfigured based on communication resources available to the first edge device.

11. The apparatus of claim 8, wherein the state information includes at least one of a position of an end point device associated with the first edge device, an orientation of the end point device, a distance between the end point device and an object, or an indication of whether the end point device is idle or performing an operation.

12. The apparatus of claim 11, wherein the state information is based on a data stream from the end point device.

13. The apparatus of claim 12, wherein the end point device is a camera, the data stream is a video data stream, and the programmable circuitry is to select a compression scheme for the video data stream based on the state information.

14. The apparatus of claim 8, wherein the programmable circuitry is to:
determine a target communication metric based on updated state information;
select a second one of the plurality of proxy data streams corresponding to the target communication metric;
halt transmission of the data based on the first one of the plurality of proxy data streams; and
cause transmission of data from the first edge device to the second edge device based on the second one of the plurality of proxy data streams.

15. An apparatus comprising:
network interface circuitry; and
programmable circuitry to be programmed by instructions to:
determine, at a first edge device, whether to (a) drop a data packet of a data stream received at the first edge device or (b) forward the data packet to a second edge device, the determination based on a payload of the data packet and historic information associated with the data stream;
based on the determination being to forward the data packet to the second edge device:
select, based on state information for the first edge device, a first one of a plurality of proxy data streams available to the first edge device in a time-sensitive network environment, the plurality of proxy data streams preconfigured in the time-sensitive network environment to satisfy respective different communication metrics; and
cause transmission of the data packet to the second edge device based on the first one of the plurality of proxy data streams; and
update the historic information based on the determination.

16. The apparatus of claim 15, wherein the programmable circuitry is to:
execute a utility function based on the payload and the historic information, a result of the execution including a utility value corresponding to the data packet, the utility value based on at least one of (a) an amount of variability between the payload and the historic information or (b) an amount of non-repeating information included in the payload and not included in one or more second data streams received at the second edge device; and
determine whether to drop the data packet or forward the data packet based on the result of the execution.

17. The apparatus of claim 16, wherein the programmable circuitry is to:
drop the data packet when the utility value does not satisfy a utility threshold; and
forward the data packet when the utility value satisfies the utility threshold.

18. The apparatus of claim 15, wherein the communication metrics correspond to at least one of bandwidth or latency of data transmitted via respective ones of the plurality of proxy data streams.

19. The apparatus of claim 15, wherein the programmable circuitry is to select a compression scheme for the data stream based on the state information.

20. The apparatus of claim 15, wherein the state information includes at least one of a position of an end point device associated with the first edge device, an orientation of the end point device, a distance between the end point device and an object, or an indication of whether the end point device is idle or performing an operation.

21-40. (canceled)
